(19) United States
(12) Patent Application Publication
(10) Pub. No.: US 2016/0185084 A1
(43) Pub. Date: Jun. 30, 2016

(54) Decorative article and laminated body for thermal transferring

(71) Applicant: TOYODA GOSEI CO., LTD., Kiyosu-shi (JP)

(72) Inventors: Koji Kuno, Kiyosu-shi (JP); Tsuyoshi Suzuki, Kiyosu-shi (JP); Yukiyoshi Soma, Ritto-shi (JP); Daisuke Miyachi, Kyoto-shi (JP); Ryohei Utsumi, Ritto-shi (JP)

(21) Appl. No.: 14/757,543

(22) Filed: Dec. 23, 2015

(30) Foreign Application Priority Data
Dec. 26, 2014 (JP) 2014-264354
Oct. 15, 2015 (JP) 2015-203795

(51) Int. Cl. B32B 15/04; B32B 7/12

(52) U.S. Cl. CPC B32B 15/04; B32B 7/12; B32B 2250/02; B32B 2255/06; B32B 2255/26; B32B 2605/00

(57) ABSTRACT

A decorative article includes a substrate having opposite surfaces, and a decorative portion formed on one of the opposite surfaces of the substrate. The decorative portion includes an adhesive layer made of resin, a metallic layer, and a protective layer made of resin. The adhesive layer, the metallic layer, and the protective layer are laminated in this order from the one of the opposite surfaces of the substrate. The metallic layer is made of a metal exhibiting an elasticity of from 10 GPa or more to 150 GPa or less. The protective layer exhibits an elasticity of from 0.5 GPa or more to 2.0 GPa or less.

### INCORPORATION BY REFERENCE

The present invention is based on Japanese Patent Application No. 2014-264354, filed on Dec. 26, 2014, and Japanese Patent Application No. 2015-203795, filed on Oct. 15, 2015, claiming the domestic priority of the former, the entire contents of which are incorporated herein by reference.

### BACKGROUND OF THE INVENTION

1. Field of the Invention

The present invention relates to a decorative article manufactured by a thermal transferring process, and a laminated body for thermal transferring that is used for manufacturing the decorative article.

2. Description of the Related Art

As a decorative article for automotive exterior application, such as front grilles, a decorative article 98, as shown in FIG. 13, has been available. As illustrated in the drawing, a decorative portion 94 including a metallic layer is formed on one of the opposite surfaces of a resinous substrate 96. As a method for forming the decorative portion 94 on the substrate 96 at the one of the opposite surfaces, a thermal transferring process has been available.

Japanese Unexamined Patent Publication (KOKAI) Gazette No. 62-282969 discloses a thermal transferring process for the purpose of forming the decorative portion 94 including a metallic layer on one of the opposite surfaces of the substrate 96. A thermal-transferring laminated body (or hot-stamping foil) 97 is formed in advances, as shown in FIG. 14. As illustrated in the drawing, the laminated body 97 comprises a release layer (or heat-resistant curable-resin layer) 91, a protective layer 92, a metallic layer (or metal-deposited layer) 93, and an adhesive layer 95 that are laminated on one of the opposite surfaces of a film (or base film) 90. With the adhesive layer 95 opposed face-to-face to one of the opposite surfaces of the substrate 96, the thermal-transferring laminated body 97 is put in place on the substrate 96 at one of the opposite surfaces. Then, the laminated body 97 is heated while it is pressurized against the substrate 96. Accordingly, the decorative portion 94 made up of the metallic layer 93 and protective layer 92 is transferred onto the one of the opposite surfaces of the substrate 96 by way of the adhesive layer 95. Finally, the film 90 and heat-resistant cured-resin layer 91 are removed off from the decorative portion 94. Consequently, the decorative article 98 is formed to be made up of the substrate 96, and the decorative portion 94 formed on the substrate 96 at one of the opposite surfaces, as shown in FIG. 13.

Incidentally, upon carrying out the thermal transfer, the thermal-transferring laminated body 97 is heated while it is pressurized against the substrate 96. On this occasion, a tensile stress is applied to the metallic layer 93 because the laminated body 97 extends. In the case of using a metal exhibiting such a high elasticity as that of chromium (Cr) for the metallic layer 93, cracks might occur in the metallic layer 93 itself, or at around the boundary between the metallic layer 93 and the protective layer 92, when a tensile stress is applied to the metallic layer 93 as aforementioned. As a result, such a fear might possibly arise as the glittering effect, which the metallic layer 93 produces, has lowered.

Moreover, an internal stress, which arises from contraction at the time of curing, accumulates in the protective layer 92. Accordingly, the stress in the contracting protective layer 92 makes a cohesive failure likely to take place in the metallic layer 93 whose cohesive force is weak. Consequently, a shear stress concentrates in the metallic layer 93 itself, or at around the boundary between the metallic layer 93 and the protective layer 92. When the decorative portion 94, to which the shear stress is thus applied, is employed in an environment whose temperature changes, or when the decorative portion 94 have suffered from damages arising therein, a cohesive failure might take place in the metallic layer 93. As a result, such another fear might possibly arise as the metallic layer 93 has become a cause of cracks in the decorative portion 94, or a cause of the occurrence of interlayer peeling or delamination that results from the metallic layer 93 undergone the cohesive failure.

When the metallic layer 93 exhibits a high elasticity, cracks in the decorative portion 94, or a cohesive failure in the metallic layer 93 becomes a cause that makes some part of the decorative portion 94 peel off from the substrate 96 after a later-described adhesion test. Moreover, when the protective layer 92 exhibits a high elasticity, an internal stress becomes higher in the protective layer 92. Accordingly, a cohesive failure is likely to take place in the metallic layer 93 in the same manner as described above. As a result, the cohesive failure arising in the metallic layer 93 becomes another cause of making some part of the decorative portion 94 peel off from the substrate 96 after the adhesion test. On the contrary, when the protective layer 92 exhibits a low elasticity, it is possible to inhibit the cohesive failure in the metallic layer 93 from resulting in peeling the decorative portion 94 off from the substrate 96. However, cracks might occur in the metallic layer 93 and protective layer 92 when thermally transferring them. Consequently, such a fear might possibly arise as the cracks have become a cause of defective appearances on the resultant decorative article.

### SUMMARY OF THE INVENTION

The present invention has been developed in view of such circumstances as described above. It is therefore an object of the present invention to provide a decorative article whose metallic layer does not cause any cohesive failure, and which enables the occurrence of cracks to be reduced in the decorative portion and to make the decorative portionless likely to peel off from the substrate. Moreover, it is another object of the present invention to provide a thermal-transferring laminated body to be used for manufacturing such a decorative article.

For example, a decorative article according to the present invention comprises:

a substrate having opposite surfaces;

a decorative portion formed on one of the opposite surfaces of the substrate, and including an adhesive layer made of resin, a metallic layer, and a protective layer made of resin, the adhesive layer, the metallic layer and the protective layer laminated in this order from the one of the opposite surfaces of the substrate;

the metallic layer made of a metal exhibiting an elasticity of from 10 GPa or more to 150 GPa or less; and

the protective layer exhibiting an elasticity of from 0.5 GPa or more to 2.0 GPa or less.

Moreover, a laminated body for heat transferring according to the present invention comprises: a protective layer made of resin, a metallic layer and an adhesive layer made of resin, the protective layer, the metallic layer and the adhesive layer laminated in this order on a film;

the metallic layer including a metal exhibiting an elasticity of from 10 GPa or more to 150 GPa or less; and

the protective layer exhibiting an elasticity of from 0.5 GPa or more to 2.0 GPa or less.

The present invention comprising the constituent element constructed as described above enables manufactures to provide a decorative article whose metallic layer does not cause any cohesive failure, and which enables the occurrence of cracks to be reduced in the decorative portion and to make the decorative portion less likely to peel off from the substrate. Moreover, the present invention also enables manufacturers to provide a thermal-transferring laminated body to be used for manufacturing such a decorative article.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a diagram for illustrating a cross section of a decorative article.

FIG. 2 is a diagram for illustrating across section of a laminated body for thermal transferring.

FIG. 3 is a scatter diagram for illustrating an elasticity and cohesive energy of various metals.

FIG. 4 is a diagram for illustrating an up/down-type hot-stamping manufacturing process.

FIG. 5 is a diagram for illustrating a roll-type hot-stamping manufacturing process.

FIG. 6 is a diagram for illustrating a decorative article according to Sample No. 2.

FIG. 7 is an optical photomicrograph of a metallic layer in a decorative article according to Sample No. 1.

FIG. 8 is a diagram for illustrating across section in the vicinity of the metallic layer of a laminated body for thermal transferring according to Sample No. 1 before being elongated and after being elongated.

FIG. 9 relates to a decorative article according to Sample No. 5, wherein: the uppermost figure is a diagram for illustrating a cross section of the decorative article after being thermally transferred; the second figure from the top is another diagram for illustrating a state in the cross section of the decorative article when a stress concentrates between its protective layer and metallic layer; the left lowermost figure is a still another diagram for illustrating another state of the decorative article when the metallic layer and protective layer are peeled off from its substrate during an adhesion test; and the right lowermost figure is a photograph of the decorative article in which the adhesion test has caused a cohesive failure in the metallic layer.

FIG. 10 is an SEM photograph of the metallic layer of the decorative article according to Sample No. 5.

FIG. 11 is a scatter diagram for illustrating relationships between a cross-linked density of the protective layer in decorative articles according to Sample Nos. 5 through 16 and an elasticity of the protective layer in the decorative articles.

FIG. 12 is a graphic diagram for illustrating relationships between a second-acrylic-polymer blended ratio and elasticity of the protective layer in decorative articles according to Sample No. 7 and Sample Nos. 10 through 16.

FIG. 13 is a diagram for illustrating a cross section of a decorative article according to Conventional Example.

FIG. 14 is a diagram for illustrating a cross section of a laminated body for thermal transferring according to Conventional Example.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

Detailed description will be hereinafter made on a decorative article according to one of embodiments of the present invention, and on a laminated body for thermal transferring that is used for manufacturing the decorative article.

### Decorative Article

A decorative article according to one of the embodiments of the present invention comprises a substrate having opposite surfaces, and a decorative portion. The decorative portion includes an adhesive layer, a metallic layer, and a protective layer that are laminated in this order from one of the opposite surfaces of the substrate. The metallic layer is made of a metal exhibiting an elasticity of from 10 GPa or more to 150 GPa or less. The protective layer exhibits an elasticity of from 0.5 GPa or more to 2.0 GPa or less.

In the decorative article according to the present embodiment, a metal with a low elasticity is used in the metallic layer, and moreover the protective layer exhibiting an elasticity, which matches up with the elasticity of the metal making the metallic layer, is used. Accordingly, even when the substrate has not only a planar configuration but also a three-dimensional configuration, the metallic layer can elongate or stretch properly. Consequently, the metallic layer is inhibited from undergoing a cohesive failure, and can thereby maintain its good glittering effect.

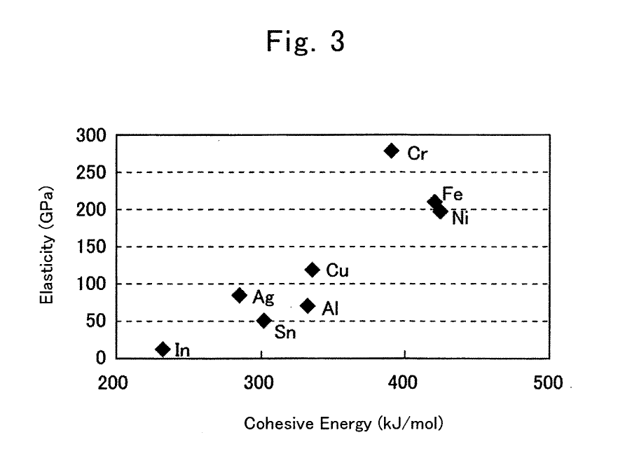

FIG. 3 illustrates relationships between an elasticity and cohesive energy of various metals. In the present specification, the “cohesive energy” is referred to an energy required for separating metallic atoms, which are cohered together, away from each other infinitely, and is found by a “first-principle calculation process.”

The elasticity of the metal, from 10 GPa or more to 150 GPa or less, is lower than an elasticity of the other various metals. Accordingly, using such a metal for the metallic layer leads to upgrading an elongation ability or stretchability of the metallic layer. Consequently, it is possible to draw out or stretch the metallic layer along with the protective layer by a pressure application at the time of thermal transferring.

When the substrate is made of a material with high thermal expansion coefficient, such as resin, the substrate is expanded and contracted by environmental temperature changes. Since the metal in the metallic layer of the decorative portion exhibits the aforementioned elasticity, the metallic layer has a high stretching or elongating capability. Consequently, as the substrate expands and contracts, the metallic layer can expand and contract accordingly. Therefore, even in an environment whose temperature changes, the metallic layer does not cause any cohesive failure, and thereby it is possible to inhibit the metallic layer from cracking and to inhibit some part of the decorative portion from coming off or peeling off from the substrate. Since it is thus possible to maintain a high glittering effect resulting from the metallic layer of the decorative portion, the present decorative article has a fine look. In particular, when the present decorative article is a vehicular exterior product, the outside-air temperature changes greatly. Even if such is the case, since it is possible to inhibit cracks from occurring in the decorative portion and to inhibit some part of the decorative portion from peeling off from the substrate after an adhesion test, it is possible for the present decorative article to maintain the fine look.

As illustrated in FIG. 3, many of the metals with a low elasticity tend to exhibit such a cohesive energy as low as 350 kJ/mol or less. Accordingly, the metallic layer made of a metal with a low elasticity tends to exhibit a small cohesive force. Since an internal stress accumulates in the protective layer due to the contraction at the time of curing, the metallic layer with a low cohesive force is less likely to follow up the accumulating internal stress in the protective layer. Consequently, a shear occurs in the metallic layer itself, or at around the boundary between the metallic layer and the protective layer. In a decorative article comprising the decorative portion that has been put in such a state, the metallic layer undergoes a cohesion failure because of such factors as temperature changes and being scratched, and eventually such a fear may possibly arise as the metallic layer and protective layer have come off or peeled off from the substrate.

Hence, in the decorative article according to the present embodiment, the protective layer is made to exhibit such an elasticity as low as from 0.5 GPa or more to 2.0 GPa or less. The protective layer with a low elasticity is soft relatively. Accordingly, it is possible to make an internal stress, which is accumulated in the protective layer by the contraction at the time of curing, smaller as well. Consequently, it is possible to reduce a shear stress that arises in the metallic layer itself or at around the boundary between the metallic layer and the protective layer. As a result, even when the completed present decorative article are subjected to stimuli such as temperature changes and being scratched, the metallic layer is inhibited from undergoing a cohesive failure. Therefore, the metallic layer and protective layer can also be inhibited from coming off or peeling off from the substrate.

Moreover, upon forming the decorative portion by a thermal transferring process, the protective layer exhibits the aforementioned elasticity. Therefore, the decorative portion exhibits a good capability of being cut to foil when a part of the decorative portion, which is bonded to one of the opposite surfaces of the substrate, is cut off from the other part, which is not bonded to the one of the opposite surfaces of the substrate.

In addition, the decorative article according to the present embodiment comprises the metallic layer including a metal exhibiting a small elasticity relatively, and the protective layer with a relatively small elasticity. Accordingly, it is possible to make a stress, which arises in the metallic layer and protective layer at the time of thermal transferring, smaller. Consequently, it is possible to inhibit the metallic layer from undergoing a cohesive failure as well as to inhibit some part of the post-adhesion-test decorative portion from peeling off from the substrate. Therefore, it is possible for the present decorative article to maintain a high glittering effect of the metallic layer.

The decorative article according to the present embodiment comprises the substrate, and the decorative portion formed on one of the opposite surface of the substrate by a thermal transferring process. In order to form the decorative portion by a thermal transferring process, a later-described laminated body for thermal transferring, which includes the protective layer, the metallic layer and the adhesive layer that are laminated in this order on a film, can be heated while pressing the thermal-transferring laminated body against the substrate. The decorative portion includes the adhesive layer, metallic layer and protective layer as mentioned above. Note that, on one of the opposite surfaces of the substrate, the adhesive layer, the metallic layer and the protective layer are laminated in this order.

In the decorative article according to the present embodiment, the metallic layer exhibits an elasticity of from 10 GPa or more to 150 GPa or less. That is, since a metal making the metallic layer exhibits an elasticity of from 10 GPa or more to 150 GPa or less, it becomes feasible to highly stretch or elongate the metallic layer. Consequently, when the substrate of the present decorative article expands and contracts, the metallic layer does not cause any cohesive failure, so that it is possible to inhibit the decorative portion from cracking and to inhibit some part of the decorative portion from peeling off from the substrate. When the metal making the metallic layer exhibits an elasticity of less than 10 GPa, the resulting metallic layer is less likely to follow up a stress arising in the protective layer. Accordingly, such a fear might possibly arise as a shear stress occurs in the metallic layer itself or at around the boundary between the metallic layer and the protective layer so that the metallic layer has undergone a cohesive failure. When the metal making the metallic layer exhibits an elasticity of more than 150 GPa, the resulting metallic layer exhibits a lowered stretching or elongating capability. Accordingly, when the decorative portion is pressurized onto the substrate at the time of thermal transferring or when the substrate expands and contracts in the present decorative article, the metallic layer causes a cohesive failure. Consequently, such a fear might possibly arise as cracks have occurred in the decorative portion or some part of the decorative portion has peeled off from the substrate after an adhesion test.

It is more preferable that the metal making the metallic layer can exhibit an elasticity of from 10 GPa or more to 100 GPa or less. It is much more preferable that the metal can exhibit an elasticity of from 10 GPa or more to 60 GPa or less. The metal exhibiting an elasticity of from 10 GPa or more to 100 GPa or less makes the metallic layer more satisfactory in the high stretching or elongating capability. Note that the elasticity of the metal making the metallic layer is measured pursuant to Japanese Industrial Standard (i.e., abbreviated hereinafter as “JIS”) “Z 2280.”

The metal making the metallic layer can preferably exhibit a cohesive energy of 350 kJ/mol or less. Moreover, the metal can more preferably exhibit a cohesive energy of 300 kJ/mol or less. In addition, the metal can much more preferably exhibit a cohesive energy of 250 kJ/mol or less.

The metal making the metallic layer and exhibiting an elasticity of from 10 GPa or more to 150 GPa or less can include one or more members selected from the group consisting of indium, tin, silver, aluminum, and copper. Among them, indium or tin is a preferable option because they exhibit a low elasticity. As far as the metal exhibits the elasticity, it can also be a metallic simple substance, or can even make an alloy.

It is preferable that the metallic layer can take on a sea-island structure in which the metal is scattered about in a shape of islands. If such is the case, the metal, which is scattered about in a shape of islands, divides or breaks down a stress that occurs at the time of stretching or elongating the metallic layer. Accordingly, cracks are inhibited from occurring in the metallic layer. Consequently, it is possible for the metallic layer to maintain its glittering effect. Moreover, it is possible to uniformly elongate the metallic layer as a whole at the time of thermal transferring. Accordingly, it is possible for the metallic layer to keep constant a reflectance to light that falls on the metallic layer. Consequently, even after the metallic layer is elongated, it is possible for the metallic layer to maintain the same look and color as it had before being stretched.

The metallic layer can be formed by wet plating or dry plating, for instance. In order to form the metallic layer with a sea-island structure as aforementioned, dry plating is a preferable process. As for dry plating, depositing processes, such as vacuum deposition, electron-beam deposition and chemical deposition, or sputtering processes can be given specifically. As for wet plating, chemical plating processes and electroplating processes can be given, for instance.

It is preferable that the metallic layer can have a thickness of from 10 nm or more to 150 nm or less. Moreover, it is more preferable that the thickness can fall in a range of from 20 nm or more to 60 nm or less. When the thickness of the metallic layer falls in a range of from 10 nm or more to 150 nm or less, the metallic layer is likely to form a sea-island structure. Accordingly, even in such an instance as the metal making the metallic layer takes on a sea-island structure, the metallic layer appears to be formed uniformly without any unevenness or concentration when the resulting present decorative article is observed visually. Consequently, the metallic layer can maintain its glittering effect.

In the decorative article according to the present embodiment, the protective layer is made of resin. Moreover, the protective layer exhibits an elasticity of from 0.5 GPa or more to 2.0 GPa or less. Upon manufacturing the present decorative article, an internal stress accumulated in the protective layer applies a shear stress to the vicinity of the boundary between the protective layer and the metallic layer, or to the metallic layer itself. In the completed present decorative article, however, the protective layer exhibiting the above-mentioned relatively low elasticity extends while adhering onto the metallic layer with a small cohesive force. Accordingly, the protective layer generates a weak shear stress. Consequently, the protective layer can keep the metallic layer from undergoing a cohesive failure, and can restrain some part of the decorative portion from peeling off from the substrate after an adhesion test. When the protective layer exhibits an elasticity of less than 0.5 GPa, such a fear might possibly arise as cracks have occurred in the resulting protective layer. When the protective layer exhibits an elasticity of more than 2.0 GPa, the shear stress, which results from the internal stress accumulated in the protective layer to act adversely between the protective layer and the metallic layer, is not weakened. Therefore, such a fear might possibly arise as the resultant protective layer and metallic layer have peeled off from the substrate.

Moreover, in the decorative article according to the present embodiment, it is more preferable that the protective layer can exhibit an elasticity of from 0.5 GPa or more to 1.8 GPa or less. It is much more preferable that the elasticity can fall in a range of from 1.0 GPa or more to 1.6 GPa or less. When the protective layer exhibits an elasticity of from 0.5 GPa or more to 1.8 GPa or less, a cohesive failure can be inhibited effectively from occurring in the metallic layer, as well as the metallic layer and protective layer can be precluded effectively from peeling off from the substrate, while letting the protective layer keep exhibiting a being-cut-to-foil capability. Note that the elasticity of the protective layer is measured pursuant to JIS “K 7161” after forming a sheet-shaped test specimen of a resin making the protective layer.

In the decorative article according to the present embodiment, the protective layer can be transparent to such an extent that makes the metallic layer visible. Since the protective layer is a layer that is formed of polymers cross-linked by a curing agent, it can preferably include a polyurethane resin. Moreover, the polyurethane resin can preferably be formed of a first acrylic polymer that is cross-linked by a curing agent with isocyanate groups. If such is the case, it is possible for the protective layer to exhibit flexibility while maintaining its rigidity to a certain extent.

Moreover, in the decorative article according to the present embodiment, the polyurethane resin in the protective layer can more preferably be formed of a first acrylic polymer and a second acrylic polymer that are cross-linked by a curing agent with isocyanate groups. The OH groups in the acrylic polymers are segments that make not only bonding sites to the curing agent but also cross-linking sites to each other. Note herein that the second acrylic polymer can much more preferably exhibit a smaller hydroxyl number than that of the first acrylic polymer. Accordingly, the cross-linking sites resulting from the curing agent are less in the second acrylic polymer than those in the first acrylic polymer. Consequently, the polyurethane resin, which is formed of the first and second acrylic polymers that are cross-linked by the curing agent, becomes softer than the polyurethane resin, which is formed of only the first acrylic polymer that is cross-linked by the curing agent, because the cross-linking sites within the protective layer are less in the former polyurethane resin than in the later polyurethane resin. Therefore, when an internal stress accumulated in the protective layer results in generating a shear stress between the metallic layer and the protective layer, the protective layer can extend more reliably while adhering to the metallic layer. Hence, it is possible to inhibit temperature changes and being scratched from causing a cohesive failure in the metallic layer. Moreover, it is also possible to preclude the metallic layer and protective layer from being peeled off from the substrate.

In the decorative article according to the present embodiment, the protective layer can be formed of a polymer that is cross-linked by a curing agent. In this instance, a cross-linked density in the protective layer, and a type of the curing agent affect an elasticity of the protective layer. Note that the “cross-linked density” herein refers to a molar quantity of cross-linking sites, which result from the curing agent within the protective layer, per a volume of the protective layer. As for the curing agent, linear or chain-shaped aliphatic compounds, aromatic compounds, or alicyclic compounds can be named. A preferable range of the cross-linked density depends on any of the compounds which the curing agent is made of.

When the curing agent is made of a chain-shaped aliphatic compound, a cross-linked density in the protective layer can preferably fall in a range of from 9.0×10⁻¹² mol/cm³ or more to 2.0×10⁻¹⁰ mol/cm³ or less, or can more preferably fall in a range of from 9.0×10⁻¹² mol/cm³ or more to 1.8×10⁻¹⁰ mol/cm³ or less. Moreover, when the curing agent is made of an aromatic compound, a cross-linked density in the protective layer can preferably fall in a range of from 2.0×10⁻¹¹ mol/cm³ or more to 4.0×10⁻¹⁰ mol/cm³ or less. In addition, when the curing agent is made of an alicyclic compound, a cross-linked density in the protective layer can preferably fall in a range of from 1.0×10⁻¹² mol/cm³ or more to 2.5×10⁻¹⁰ mol/cm³ or less. When the cross-linked density in the protective layer is much less than the lower limits of the aforementioned ranges, such a fear might possibly arise as the protective layer is so soft to be likely to be scratched. When the cross-linked density in the protective layer is much more than the upper limits of the aforementioned ranges, the rigidity of the protective layer becomes so high to possibly lead to such a fear as a shear stress, which occurs between the protective layer and the metallic layer when the protective layer cures to contract, has caused a cohesive failure in the metallic layer. As a result, such another fear might possibly arise as some part of the decorative portion has peeled off from the substrate after an adhesion test.

A cross-linked density “n” in the protective layer can be calculated by Equation (A) below.

n=E′/3RT Equation (A)

where “E′” is a storage elastic modulus; “R” is the gas constant; and “T” is an absolute temperature.

Note that the storage elastic modulus of the protective layer can be measured by a dynamic viscoelasticity measurement apparatus (e.g., manufactured by RHEOLOGY Corporation, named “FT REOSPECTRA,” and typed as “DVE-V4”).

The polyurethane resin in the protective layer can include a group exhibiting photostability performance, and/or a group exhibiting ultraviolet-absorption performance. Moreover, the polyurethane resin in the protective layer can further include a group exhibiting water-resistance performance. In addition, a prior-to-thermal-curing first acrylic polymer and/or second acrylic polymer can include one of those groups. As for a group exhibiting photostability performance, groups with a hindered amine skeleton can be named, for instance. As for a group exhibiting ultraviolet-absorption performance, groups with a benzotriazole skeleton, and groups with a triazine skeleton can be named, for instance. As for a group exhibiting water-resistance performance, saturated aliphatic rings can be named, for instance. The polyurethane resin including group exhibiting such a functionality can provide the protective layer with photostability, ultraviolet absorbability, or water resistance. The protective layer, which is made of the polyurethane resin including one of those groups, enables the decorative article according to the present embodiment to demonstrate sufficient weatherability and durability, even when the protective layer is not covered with any overcoat paint film.

In the decorative article according to the present embodiment, the protective layer can preferably include a first acrylic polymer, and a curing agent with isocyanate groups. Moreover, the protective layer can more preferably be formed by cross-linking a first acrylic polymer with a curing agent having isocyanate groups. In addition, the protective layer can much more preferably include a polyurethane resin formed by cross-liking a first acrylic polymer by a curing agent having isocyanate groups. The polyurethane resin formed by cross-liking the first acrylic polymer with the curing agent having isocyanate groups is also referred to as an “acrylic polyurethane resin.” The resulting acrylic polyurethane resin includes blocks of the first acrylic polymer.

As for a monomer of the first acrylic polymer, acrylic acid, methacrylic acid, acrylate esters, and methacrylate esters can be named, for instance. Among the options, the acrylate esters or methacrylate esters can further include a group exhibiting functionality which is ester-bonded to acrylic acid or methacrylic acid. As the group exhibiting functionality, groups exhibiting photostability performance, groups exhibiting ultraviolet-absorption performance, and groups exhibiting water-resistant performance can be named, for instance. As for a group exhibiting photostability performance, groups with a hindered amine skeleton can be named, for instance. As for a group exhibiting ultraviolet-absorption performance, groups with a benzotriazole skeleton, and groups with a triazine skeleton can be named, for instance. As for a group exhibiting water-resistance performance, saturated aliphatic rings can be named, for instance. Polymerizing an acrylate ester or methacrylate ester including a group exhibiting such a functionality results in making it possible to provide the protective layer with a variety of functions.

Note that all the monomer species of the first acrylic polymer can even be bonded with each other in any arrangement in the resulting first acrylic polymer.

The first acrylic polymer can be synthesized by letting an acrylation reaction take place by carrying out such a publicly-known method as applying heat or adding a polymerization initiator to a monomer of the first acrylic polymer.

It is preferable that the first acrylic polymer can include constituent repeat units in which groups with a hindered amine skeleton are ester bonded. If such is the case, photostability performance is given to the resulting first acrylic polymer.

It is preferable that the first acrylic polymer can include constituent repeat units in which groups with a benzotriazole skeleton or triazine skeleton are ester bonded. If such is the case, ultraviolet-absorption performance is given to the resulting first acrylic polymer.

It is preferable that the first acrylic polymer can preferably be an acrylic polymer that is produced by polymerizing at least one of the following: an acrylic acid or methacrylic acid; an acrylate ester or methacrylate ester including a group with a hindered amine skeleton; and an acrylate ester or methacrylate ester including a group with a benzotriazole skeleton or triazine skeleton. It is possible for the decorative portion, which is formed of such a first acrylic polymer and a curing agent, to demonstrate photostability as well as ultraviolet-absorption performance.

The first acrylic polymer can preferably have a construction expressed by Chemical Formula (1) below.

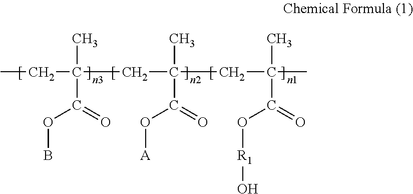

In Chemical Formula (1), “A” specifies a group with a benzotriazole skeleton or triazine skeleton; “B” specifies another group with a hindered amine skeleton; “R₁” specifies a carbon-containing group; and “n1,” “n2” and “n3” are an integer of zero or more. Note however that the case where “n1”=“n2”=“n3”=0 is excluded from the construction shown above.

It is preferable that the first acrylic polymer can exhibit a hydroxyl number of from 20-mg KOH or more to 200-mg KOH or less per one-gram sample. Moreover, it is more preferable that the first acrylic polymer can exhibit a hydroxyl number of from 20-mg KOH or more to 100-mg KOH or less per one-gram sample. The “hydroxyl number” refers to a quantity of KOH in milligrams required for acetylating OH groups contained in a one-gram sample. Note that the hydroxyl number of the first acrylic polymer is measured pursuant to JIS “K 0070.”

The OH groups in the first acrylic polymer can make cross-linking sites which are cross-linked to isocyanate groups in the curing agent through the urethane bond. When the hydroxyl number of the first acrylic polymer is too small, the reactivity between the first acrylic polymer and the curing agent lowers. Accordingly, an elasticity of the resulting protective layer is so low that such a fear might possibly arise as cracks have occurred in the metallic layer and protective layer when thermally transferring the decorative portion. On the other hand, when the hydroxyl number of the first acrylic polymer is too large, an elasticity of the resultant protective layer is too high. Consequently, a curing contraction force enlarges in the protective layer when it is cured to contract, so that a shear stress acts between the protective layer and the metallic layer. As a result, such a fear might possibly arise as temperature changes and being scratched have caused the metallic layer to crack and eventually peel off.

It is preferable that a resin in the protective layer can further include a second acrylic polymer exhibiting a hydroxyl number that is lower than the hydroxyl number of the first acrylic polymer, because such a resin makes it likely to adjust the elasticity of the protective layer to a desired elasticity.

It is preferable that the protective layer can further include a second acrylic polymer whose hydroxyl number is lower than the hydroxyl number of the first acrylic polymer, in addition to the first acrylic polymer and curing agent. Moreover, it is more preferable that the protective layer can be formed by cross-linking the first acrylic polymer and second acrylic polymer with each other by a curing agent with isocyanate groups. In addition, it is much more preferable that the protective layer can include a polyurethane resin that is formed by cross-linking the first acrylic polymer and second acrylic polymer with each other by a curing agent with isocyanate groups. The polyurethane resin formed of the first acrylic polymer and second acrylic polymer that are cross-linked by the curing agent with isocyanate groups is also referred to as an “acrylic polyurethane resin.” The resulting acrylic polyurethane resin includes blocks of the first acrylic resin, and other blocks of the second acrylic resin.

The OH groups in the second acrylic polymer can make cross-linking sites which react with isocyanate groups in the curing agent. The protective layer, which includes the first acrylic polymer with cross-linking sites and the second acrylic polymer with less cross-linking sites than the cross-linking sites in the first acrylic polymer, leads to making it possible to more appropriately lower an elasticity of the resulting protective layer. Accordingly, the accumulation of an internal stress, which arises from the contraction of the curing protective layer, is reduced. Consequently, a shear stress acting between the protective layer and the metallic layer is kept low. As a result, it is possible to further inhibit cracks from occurring in the metallic layer, and to further preclude the protective layer from peeling off from the metallic layer.

It is preferable that the second acrylic polymer can exhibit a hydroxyl number of from more than 0-mg KOH to 30-mg KOH or less per one-gram sample. Moreover, it is more preferable that the second acrylic polymer can exhibit a hydroxyl number of from more than 0-mg KOH to 15-mg KOH or less per one-gram sample. Note that a hydroxyl number of the second acrylic polymer can be measured by the same measurement method as that for measuring a hydroxyl number of the first acrylic polymer.

Regarding various skeletons making up the second acrylic polymer, they can be the same skeletons as those skeletons making up the first acrylic polymer. For example, it is preferable that the first acrylic polymer and/or the second acrylic polymer can include one or more members selected from the group consisting of groups with a hindered amine skeleton, groups with a benzotriazole skeleton, and groups with a triazine skeleton. Moreover, as for a monomer of the second acrylic polymer, it is possible to use the same monomers as those monomers to be used for the first acrylic polymer, for instance.

In the protective layer of the decorative article according to the present embodiment, a content of the second acrylic polymer can preferably fall in a range of from more than 0% by mass to 85% by mass or less, or can more preferably fall in a range of from 5% by mass or more to 75% by mass or less, when a summed mass of the first acrylic polymer and second acrylic polymer is taken as 100% by mass. The content of the second acrylic polymer that is from more than 0% by mass to 85% by mass or less makes it possible to reduce an internal stress resulting from the contracting protective layer at the time of curing. Accordingly, the protective layer can securely adhere more closely onto the metallic layer which exhibits a weak cohesive force. When the content of the second acrylic polymer is 0% by mass, an internal stress resulting from the contraction of the curing protective layer accumulates greatly, so that such a fear might possibly arise as a shear stress, which occurs between the metallic layer and the protective layer, has caused the metallic layer to undergo a cohesive failure, or has caused the metallic layer and protectively layer to peel off from the substrate. When the content of the second acrylic polymer goes beyond 85% by mass to be excessive, such another fear might possibly arise as cracks have occurred in the protective layer at the time of thermal transferring, because the protective layer has a weak cohesive force.

In the decorative article according to the present embodiment, the protective layer can include a curing agent with isocyanate groups. As for the curing agent with isocyanate groups, linear or chain-shaped aliphatic compounds, aromatic compounds, and alicyclic compounds can be named. Among them, a chain-shaped aliphatic compound is preferable. As for the chain-shaped aliphatic compounds, HDI-based (i.e., hexadiisocyanate-based) compounds can be named, for instance. As for the alicyclic compounds, IPDI-based (i.e., isophoronediisocyanate-based) compounds, can be named, for instance. As for the aromatic compounds, TDI-based (i.e., tolylene diisocyanate-based) compounds, and XDI-based (i.e., xylene diisocyanate-based) compounds can be named, for instance. Among the above options, an HDI-based compound is especially preferable. A polyurethane resin, which is cross-linked by an HDI-based curing agent to form, tends to exhibit a low elasticity. As a result, the protective layer including an HDI-based curing agent becomes less likely to peel off from the metallic layer after being thermally transferred. Note herein that the HDI-based, IPDI-based, TDI-based and XDI-based compounds signify various isocyanates, and their modified forms. As examples of the modified forms the following can be named: adducted derivatives of various isocyanates, isocyanurate derivatives thereof, burette derivatives thereof, and allophanate derivatives thereof.

In the decorative article according to the present embodiment, a mass of the curing agent included in the protective layer can preferably fall in a range of from five parts by mass or more to 80 parts by mass or less, or can more preferably fall in a range of from 15 parts by mass or more to 50 parts by mass or less, when a summed mass of the first acrylic polymer and second acrylic polymer, which are included in the protective layer, is taken as 100 parts by mass. The mass of the curing agent that is from five parts by mass or more to 80 parts by mass or less makes it possible to more moderately cross-link the first acrylic polymer and second acrylic polymer by the curing agent. When the mass of the curing agent is less than five parts by mass, such a fear might possibly arise as a being-cut-to-foil capability of the protective layer has declined. When the mass of the curing agent is more excessive than 80 parts by mass, a consumption efficiency of the curing agent is poor since the curing agent in excess remains to be unreacted in the protective layer. That is because the excessive curing agent has been present much more than OH groups that the first acrylic polymer and second acrylic polymer have, and which serve as cross-linking sites in the resulting acrylic polyurethane resin.

Moreover, a summed mass of the first acrylic polymer, second acrylic polymer and curing agent can preferably account for from 60% by mass or more to 100% by mass or less, or can more preferably account for from 80% by mass or more to 100% by mass or less, or can much more preferably account for from 90% by mass or more to 100% by mass or less, when a mass of the protective layer is taken as 100% by mass.

In the decorative article according to the present embodiment, the protective layer includes the aforementioned first acrylic polymer and curing agent, and can further include the second acrylic polymer, if needed. In addition to the first acrylic polymer, curing agent and second acrylic polymer, the protective layer can further include an additive agent as well. As for the additive agent capable of being further included in the protective layer, publicly-known additive agents, such as yellowing inhibitor agents, are available, for instance. Note that the additive agent can preferably account for from more than 0% by mass to less than 40% by mass, or can more preferably account for from more than 0% by mass to less than 20% by mass, when a mass of the protective layer is taken as 100% by mass.

Moreover, contrary to structures with various functions that are mixed with a polyurethane resin as additives, the decorative article according to the present embodiment involves the structures in a polyurethane resin as the bonding groups. Therefore, it is possible for the present decorative article to sustainably demonstrate the various functions for a long period of time.

The protective layer can preferably have a thickness of from 1 μm or more to 10 μm or less, or can more preferably have a thickness of from 1 μm or more to 7 μm or less. Moreover, an overcoat paint film can be further formed on a surface of the protective layer (i.e., an outermost surface of the decorative article according to the present embodiment), or no overcoat paint film can be formed thereon. When the protective layer is made of a polymer including groups with photostability performance or groups with ultraviolet-absorption performance, the present decorative article can demonstrate excellent weatherability even without any overcoat paint film.

The decorative article according to the present embodiment can further include a top layer intervening between the adhesive layer and the metallic layer. If such is the case, it is possible to inhibit cracks from occurring in the metallic layer, because an adhesive agent, which melts to soften at the time of thermal transferring, is free from directly contacting with the metallic layer which deforms in a lesser magnitude. The top layer can be made of resin. Moreover, the top layer can preferably be made of the same resin as that makes the protective layer. In addition, resinous-component ratios (or component ratios between the first acrylic polymer, the second acrylic polymer and the curing agent) in the protective layer can preferably be identical with resinous-component ratios in the top layer. If so, when the metallic layer has a sea-island structure, a resin in the top layer, and the resin in the protective layer can go into the metallic layer to make a sea component in the metallic layer. Since setting a resin in the top layer to be identical with a resin in the protective layer improves compatibility between the top layer and the protective layer, the top layer and protective layer can exert a strong anchoring effect on the metallic layer. Note that the top layer can preferably have a thickness of from 0.01 μm or more to two μm or less, or can more preferably have a thickness of from 0.01 μm or more to one μm or less.

In the decorative article according to the present embodiment, the adhesive layer is formed between the metallic layer and the substrate. However, when the present decorative article further includes the top layer, the adhesive layer is formed between the top layer and the substrate. The adhesive layer bonds the decorative portion to the substrate, or vice versa. As for a resin included in the adhesive layer, acrylic resins, chlorinated polypropylene-based resins, chlorinated polyvinyl acetate-based resins, and polyester-based resins can be named, for instance. Note that the adhesive layer can preferably have a thickness of from 0.5 μm or more to five μm or less.

As for the substrate, resins, metals, and woods can be named, for instance. Among them, the substrate can be made of a resin.

The decorative article according to the present embodiment can be used in exterior and interior products for vehicle, such as a front grille, aback panel and ornaments, for instance.

The decorative article according to the present embodiment can preferably be manufactured by a thermal transferring process using a thermal-transferring laminated body described below. However, the manufacturing process is not limited to the thermal transferring process at all.

### Laminated Body for Thermal Transferring

A laminated body for thermal transferring according to one of embodiments of the present invention is a transferable foil comprising: a film; and a decorative portion formed on the film. As for a material used in the film, polyesters (such as polyethylene terephthalate (or PTFE)), polypropylene, polycarbonate, polyvinyl chloride, and polystyrene can be named, for instance. Note that the film can preferably have a thickness of from 16 μm or more to 50 μm or less.

The decorative portion is formed on the film. In order to upgrade the decorative layer in the releasability, a release layer can even intervene between the film and the decorative layer. The release layer is a layer made of resin. The resin employed in the release layer is not restricted at all especially as far as it is a resin being capable of achieving the specific purpose. As the resin, the following are employable: waxes; or various publicly-known resins, such as polyethylene-based resins, polypropylene-based resins, polystyrene-based resins, polyvinyl chloride-based resins, polyester-based resins, acrylic resins, polyurethane-based resins, melamine-based resins, epoxy-based resins, and fluorine-based resins. Moreover, depending on specific needs, any one member of the resins can be selected appropriately, or two or more members of them can even be selected to make a resin mixture. Note that the release layer can preferably have a thickness of from 0.1 μm or more to two μm or less.

In the thermal-transferring laminated body according to the present embodiment, a protective layer, a metallic layer, and an adhesive layer are laminated in this order from one of the opposite sides of the film to form the decorative portion.

As the protective layer in the thermal-transferring laminated body according to the present embodiment, it is possible to use the same protective layer as that of the decorative article according to the above-described present embodiment.

The thermal-transferring laminated body according to the present embodiment can preferably further includes a top layer laminated between the metallic layer and the adhesive layer. The top layer is made of resin. It is preferable that the top layer can include the same resin as that makes the protective layer. For example, when the protective layer includes a first acrylic polymer and curing agent, it is preferable that the top lay can also include the first acrylic polymer and curing agent.

Moreover, resinous-component ratios (or component ratios between the first acrylic polymer, the curing agent and a second acrylic polymer) in the protective layer can more preferably be identical with resinous-component ratios in the top layer. If so, when the metallic layer has a sea-island structure, a resin in the top layer, and the resin in the protective layer can go into the metallic layer to make a sea component in the metallic layer. Since setting a resin in the top layer to be identical with a resin in the protective layer improves compatibility between the top layer and the protective layer, the top layer and protective layer can exert a strong anchoring effect on the metallic layer. Note that the top layer can preferably have a thickness of from 0.01 μm or more to two μm or less, or can more preferably have a thickness of from 0.01 μm or more to one μm or less.

In the thermal-transferring laminated body according to the present embodiment, the adhesive layer bonds the decorative portion to a thermal-transferring mating substrate, or vice versa. As for a resin included in the adhesive layer, polyacrylate resins, chlorinated polypropylene-based resins, chlorinated polyvinyl acetate-based resins, and polyester-based resins can be named, for instance. Note that the adhesive layer can preferably have a thickness of from 0.5 μm or more to five μm or less.

It is possible to form any of the release layer, protective layer, top layer and adhesive layer, respectively, by a coating process, which has been known heretofore publicly, such as a gravure coating process, a reverse coating process and a die coating process.

The decorative portion of the thermally-transferring laminated body according to the present embodiment is thermally transferred onto a substrate. Before thermally transferring the decorative portion, the present thermally-transferring laminated body is put in place on the substrate. Then, the present thermally-transferring laminated body is pressurized while being heated. Thus, the present thermally-transferring laminated body is pressed against one of the opposite surfaces of the substrate. When the decorative portion is cooled, the decorative portion is bonded to the substrate at the bonded parts which are bonded to the opposite surface of the substrate. When the film is thereafter removed from the opposite surface of the substrate, the decorative portion is separated off from its own bonded parts at the non-bonded parts which have not been bonded to the opposite surface of the substrate. Then, the non-bonded parts of the decorative portion are taken away from the opposite surface of the substrate along with the film. Thus, the parts of the decorative portion, which have been bonded to the opposite surface of the substrate, are transferred to the opposite surface of the substrate.

The film can preferably be removed from the opposite surface of the substrate after the protective layer, top layer and adhesive layer are cooled to solidify, because the solidified protective layer, top layer and adhesive layer improve the decorative portion in the being-cut-to-foil capability. Moreover, the decorative portion can be transferred reliably to the substrate, because the film is removed from the substrate after the decorative portion has been bonded securely to the substrate.

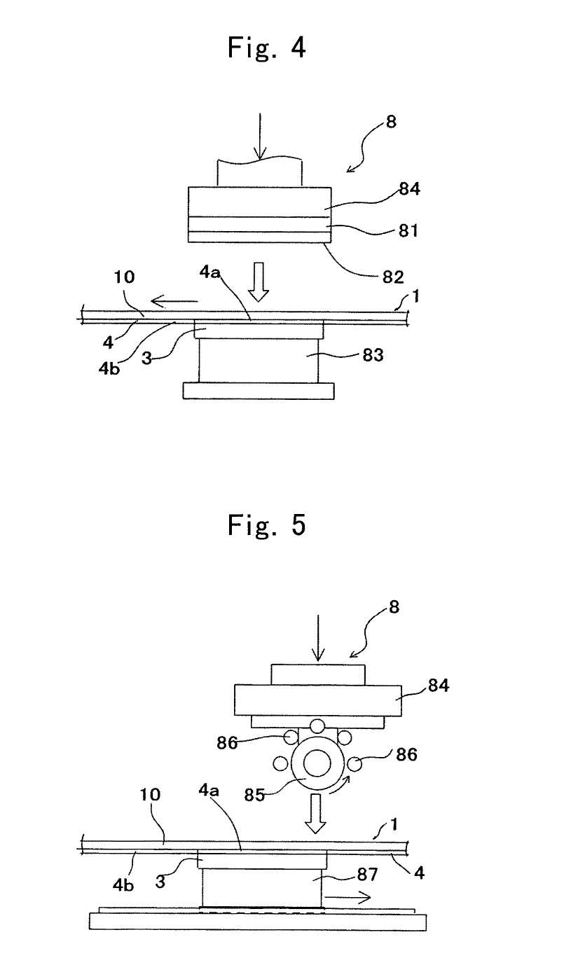

For the thermal transferring operation, hot stamping processes, and in-mold processes (or simultaneous molding/transferring processes) are available, for instance. As the hot stamping processes, the following can be named: a process employing an up/down-type hot stamping apparatus 8 shown in FIG. 4; and another process employing a roll-type hot stamping apparatus shown in FIG. 5, for instance. As illustrated in FIG. 4, the up/down-type hot stamping apparatus 8 comprises a pressurizer 84 including a hot platen 81 and a rubber impression 82, and a table 83. The rubber impression 82 heated by the hot platen 81 moves up and down, and a laminated body. 1 for thermal transferring is made movable horizontally. The thermal-transferring laminated body 1 is put in place on a substrate 3 that is present on the table 83. Then, the thermal-transferring laminated body 1 is pressed against the substrate 3 by the rubber impression 82. As a result, the decorative portion 4 of the thermal-transferring laminated body 1 is transferred onto the substrate 3.

As illustrated in FIG. 5, the roll-type hot stamping apparatus 8 comprises a movable table 87, and a pressurizer 84 including a rotary rubber roll 85 and heat sources 86 put in place around the rotary rubber roll 85. The roll-type hot stamping apparatus 8 carries out the process of thermally transferring the decorative portion 4 of the thermal-transferring laminated body 1 to the substrate 3 by first descending the rotary rubber roll 85 heated by the heat sources 86; and then moving the movable table 87 horizontally while pressurizing the thermal-transferring laminated body 1.

Note that it is preferable that either of the up/down-type hot-stamping apparatus 8 and the roll-type hot stamping apparatus 8 can heat the thermal-transferring laminated body 1 to such a temperature as falling in a range of from 100 to 150° C.

### EXAMPLES

Various decorative articles according to Sample Nos. 1 through 16 were produced by a thermal transferring process with laminated bodies for thermal transferring, and were subjected to evaluations. Note that Sample Nos. 7 through 15 were articles according to the present invention, but Sample Nos. 1 through 6 and Sample No. 16 were referential articles.

### Sample No. 1

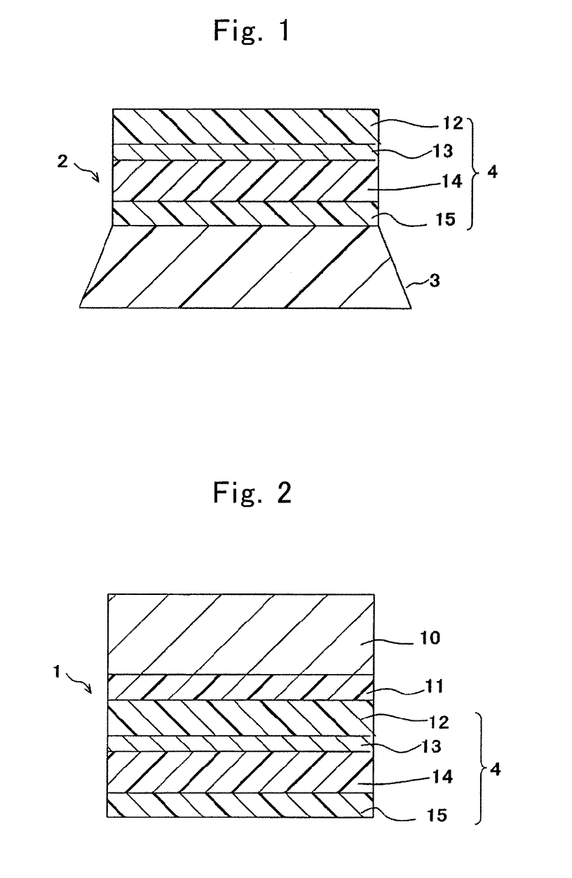

As illustrated in FIG. 1, a decorative article according to Sample No. 1 comprised a substrate 3, and a decorative portion 4 formed on one of the opposite surfaces of the substrate 3. The decorative portion 4 was formed by laminating an adhesive layer 15, a top layer 14, a metallic layer 13 and a protective layer 12 in this order from the superficial face side of the substrate 3. The substrate 3 was made of a polypropylene resin. The adhesive layer 15 was made of a chlorinated polypropylene-based resin. The top layer 14 and protective layer 12 were made of a later-described acrylic polyurethane resin that was formed by cross-linking a first acrylic polymer and a second acrylic polymer one another with a curing agent. The metallic layer 13 was made of chromium. Hereinafter, a method of preparing the decorative article 2 will be described.

First of all, a laminated body 1 for thermal transferring was made ready. As illustrated in FIG. 2, the thermal-transferring laminated body 1 comprised a release layer 11, a protective layer 12, a metallic layer 13, a top layer 14 and an adhesive layer 15 laminated in this order onto one of the opposite surfaces of a film 10.

In order to prepare the thermal-transferring laminated body 1, the film 10, which was made of polyethylene terephthalate and had a thickness of 25 μm, was made ready first of all. Then, the release layer 11 whose thickness was 0.5 μm was formed by applying a thermoplastic resin including a melamine resin onto the film 10 by a gravure coating process.

The first acrylic polymer, the second acrylic polymer, and the curing agent were mixed with each other to obtain a mixed resin “A.” Both of the first acrylic polymer and second acrylic polymer were polymers in which the following were polymerized with each other: a methacrylate ester (or HMA) having hydroxyl groups; a methacrylate ester (or HAMA) having a hindered amine skeleton; another methacrylate ester (or BTMA) having a benzotriazole skeleton; and still another methacrylate ester (or CHMA) having cyclohexane rings. A blending molar ratios between the monomers was set as HMA:HAMA:BTMA:CHMA=12:2:5:81 for the first acrylic polymer, and was set as HMA:HAMA:BTMA:CHMA=3:2:5:90 for the second acrylic polymer. The first acrylic polymer exhibited a hydroxyl number of 39-mg KOH per one-gram sample. The second acrylic polymer exhibited a hydroxyl number of 8-mg KOH per one-gram sample. The hydroxyl numbers were measured pursuant to JIS “K0070.” Moreover, the first acrylic polymer had a weight average molecular weight of 30,000. The second acrylic polymer had a weight average molecular weight of 80,000.

The first acrylic polymer and second acrylic polymer had a construction expressed by Chemical Formula (2) below. In the first acrylic polymer and second acrylic polymer, the benzotriazole skeleton and the acrylic acids were bonded with each other chemically, and the hindered amine skeleton and the acrylic acids were bonded with each other chemically.

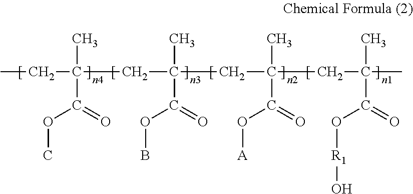

In Chemical Formula (2), “A” specifies a group with a benzotriazole skeleton; “B” specifies another group with a hindered amine skeleton; “C” specifies a cyclohexyl group; “R₁” specifies a carbon-containing group; and “n1,” “n2,” “n3” and “n4” are an integer of one or more.

The curing agent was made of a TDI nurate-type trimer with a construction expressed by Chemical Formula (3) below.

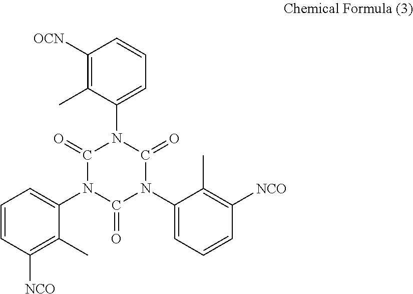

When a summed mass of the first acrylic polymer and second acrylic polymer in the mixed resin was taken as 100% by mass, the first acrylic polymer was set to account for 50% by mass, and accordingly the second acrylic polymer was set to account for 50% by mass. Moreover, when a summed mass of the first acrylic polymer and second acrylic polymer was taken as 100 parts by mass, a mass of the curing agent was set to account for 25 parts by mass. The mixed resin “A” was applied to an exposed surface of the release layer by a gravure coating process, thereby forming the protective layer 12 whose thickness was four μm. In the thus formed protective layer 12, a heat at the time of drying the gravure-coated paint film caused a cross-linking reaction to progress. Accordingly, both the first acrylic polymer and second acrylic polymer were cross-linked with each other partially by the curing agent. Consequently, an acrylic polyurethane resin was formed in the protective layer 12.

Chromium was vapor deposited onto an exposed surface of the protective layer 12 by a physical vapor deposition (or PVD) process, thereby forming the metallic layer 13 made of chromium and having a thickness of 30 nm. In the thermal-transferring laminated body 1, the metallic layer 13 made of chromium did not have any sea-island structure, but had a flat structure. The chromium in the metallic layer 13 was measured for the elasticity pursuant to JIS “Z 2280,” and was found to have an elasticity of 279 GPa. Moreover, the chromium was found to have a cohesive energy of 389 kJ/mol.

The above-described mixed resin “A” was applied again to an exposed surface of the metallic layer 13 by a gravure coating process, thereby forming the top layer 14 whose thickness was 0.1 μm. In the thus formed top layer 14, a heat at the time of drying the gravure-coated paint film caused a cross-linking reaction to progress.

Accordingly, both the first acrylic polymer and second acrylic polymer were cross-linked with each other partially by the curing agent. Consequently, an acrylic polyurethane resin was formed in the top layer 14.

An adhesive agent made of chlorinated polypropylene was applied to an exposed surface of the top layer 14 by a gravure coating process, thereby forming the adhesive layer 15 whose thickness was 1.5 μm. Via the application steps described above, the thermal-transferring laminated body 1 was obtained.

The thermal-transferring laminated body 1, and the up/down-type hot stamping apparatus shown in FIG. 4 were used to form the decorative portion 4 onto the substrate 3. As a material for the substrate 3, a polypropylene resin was chosen. As illustrated in FIG. 4, the up/down-type hot stamping apparatus 8 comprised a pressurizer 84, and a table 83. The pressurizer 84 included a hot platen 81, and a rubber impression 82. The hot platen 81 heated the rubber impression 82 to 180° C. The heated rubber impression 82 moved up and down. The thermal-transferring laminated body 1 was movable horizontally. The thermal-transferring laminated body 1 was put in place on the substrate 3 that was placed on the table 83. Then, the thermal-transferring laminated body 1 was pressed against the substrate 3 by the rubber impression 82. As a result, the decorative portion 4 of the thermal-transferring laminated body 1 was fixed onto an upper surface of the substrate 3 via the softening or melting adhesive layer 15. Note that, in the protective layer 12 and top layer 14 of the decorative portion 4, the curing agent caused to further develop the cross-linking reaction among the first acrylic polymer and the second acrylic polymer to further form an acrylic polyurethane resin.

After the above-described transferring operation, the pressurizer 84 was raised. Thereafter, the decorative portion 4 was cooled, and then the film 10 was brought upward. As a result, a bonded part 4a in the decorative portion 4, which had been bonded on the upper surface of the substrate 3, was cut off from a non-bonded part 4b in the decorative portion 4, which had not been bonded on the upper surface of the substrate 3. Accordingly, the bonded part 4a in the decorative portion 4 remained on the upper surface of the substrate 3, but the non-bonded part 4b in the decorative portion 4 was removed from the substrate 3, along with the film 10. Consequently, the bonded part 4a in the decorative portion 4 was transferred on the upper surface of the substrate 3. Thus, the decorative article 2 according to Sample No. 1 was obtained.

The protective layer 12 in the decorative article 2 according to Sample No. 1 was measured for the elasticity pursuant to JIS “K 7161,” and was found to have an elasticity of 1.60 GPa. Moreover, the protective layer 12 had a cross-linked density of “9.75E-11” (i.e., 9.75×10⁻¹¹) mol/cm³. The cross-linked density was a value that was calculated by above-described Equation (A) after measuring the protective layer 12 for the storage elastic modulus with use of the above-exemplified dynamic viscoelasticity measurement apparatus.

### Sample No. 2

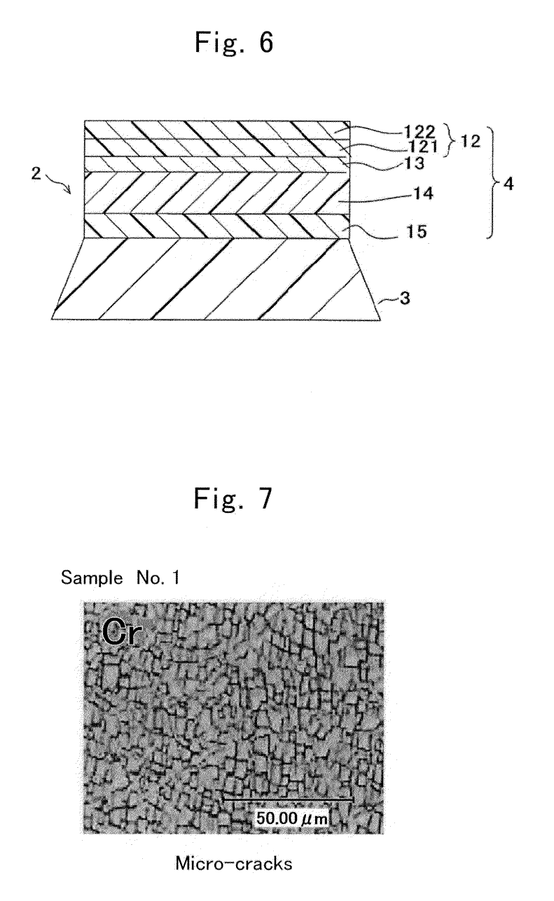

As illustrated in FIG. 6, a decorative article 2 according to Sample No. 2 comprised a decorative layer 12 including a lower layer 121 and an upper layer 122. The lower layer 121 was made of an acrylic polyurethane resin formed by cross-linking an acrylic polymer with a curing agent. The upper layer 122 was made of an acrylic polymer. The acrylic polymer in the upper layer 122 was not cross-linked at all. Monomers of the acrylic polymer making the lower layer 121 and upper layer 122 involved neither a methacrylate ester with a hindered amine skeleton nor a methacrylate ester with a benzotriazole skeleton. The lower layer 121 had a thickness of three μm. The upper layer 122 had a thickness of 1.5 μm.

The decorative article 2 according to Sample No. 2 was formed by a thermal transferring process in which a laminated body for thermal transferring was used in the same manner as Sample No. 1. In the thermal-transferring laminated body, the lower layer 121 was made a mixed resin including the acrylic polymer and the curing agent, whereas the upper layer 122 was made using the acrylic polymer alone. When the decorative article 2 according to Sample No. 2 was completed by a thermal transferring process with the thermal-transferring laminated body, an acrylic polyurethane resin was formed in the lower layer 121, whereas only the acrylic polymer was present as it was in the upper layer 122.

The lower layer 121 of the protective layer 12 in the decorative article 2 according to Sample No. 2 had an elasticity of 2.50 GPa. Moreover, the lower layer 121 had a cross-linked density of “7.50E-10” (i.e., 7.50×10⁻¹⁰) mol/cm³. Meanwhile, the upper layer 122 of the protective layer 12 in the decorative article 2 according to Sample No. 2 had an elasticity of 0.35 GPa.

The other settings in the decorative article 2 according to Sample No. 2 were the same as those in the decorative article 2 according to Sample No. 1.

### Sample No. 3

An upper layer 122 of a protective layer 12 in a decorative article 2 according to Sample No. 3 included: an acrylic polymer in an amount of 88% by mass; a hindered amine-based compound in an amount of 4% by mass; and a triazine-based compound in an amount of 8% by mass; when a mass of the upper 122 was taken as 100% by mass. The hindered amine-based compound was produced by BASF Corporation, and had such a product name as “TINUVIN123.” The triazine-based compound was also produced by BASF Corporation, and had such a product name as “NUVIN384-2.” The upper layer 122 of the protective layer 12 in the decorative article 2 according to Sample No. 3 had an elasticity of 0.34 GPa. Other than the upper layer 122 of the protective layer 12, the decorative article 2 according to Sample No. 3 was set to comprise the same constituent elements as those of the decorative article 2 according to Sample No. 2.

### Sample No. 4

Except that an upper layer 122 of a protective layer 12 in a decorative article 2 according to Sample No. 4 had a thickness of three μm, the decorative article 2 according to Sample No. 4 comprised the same constituent elements as those of the decorative article 2 according to Sample No. 3. Specifically, in the decorative article 2 according to Sample No. 4, each of the upper layer 122 and lower layer 121 of the protective layer 12 had the same elasticity and cross-linked density as those which the counterparts had in the decorative article 2 according to Sample No. 3.

### Experiment No. 1

The decorative articles 2 according to Sample Nos. 1 through 4 were evaluated for the adherability, being-cut-to-foil capability, ultraviolet absorbability, and appearance in the following manners.

1) The adherability was evaluated by carrying out a tape adhesion test pursuant to JIS “5401.” The testing conditions were set as follows: cutting the decorative article 2 at intervals of 2 mm into 100 (i.e., 10×10) grids. After adhering a tape onto the cut decorative article 2 and removing the tape therefrom, the decorative article 2 was rated as “◯” (i.e., “good”) when no peeling off occurred in the decorative portion 4; whereas the decorative article 2 was rated as “X” (i.e., poor) when any peeling off occurred therein.

2) The being-cut-to-foil capability was evaluated by the likeliness of being cut off when cutting the thermal-transferring laminated body 1 at the part in contact with the substrate 3 from the other part not in contact therewith. The decorative article 2 was rated as “X” (i.e., poor) when any burr or flash occurred in the decorative portion 4 transferred on one of the opposite surfaces of the substrate 3 at the time of cutting off, or when any chip or notch occurred at the time of thermal transferring; whereas the decorative article 2 was rated as “◯” (i.e., “good”) when neither burr or flash nor chip or notch occurred.

3) The ultraviolet absorbability was evaluated as follows: a film consisted of the same decorative portion 4 as that of each of Sample Nos. 1 through 4 was first formed onto a polyethylene terephthalate (or PET) film; and each of the resulting films was measured for the light transmittance when being irradiated with a light falling in an ultraviolet region with a wavelength of from 300 to 360 nm. The film was rated as “◯” (i.e., “good”) when it exhibited the light transmittance of 10% or less; was rated as “Δ” (i.e., “fair”) when it exhibited the light transmittance of from more than 10% to 80% or less; and was rated as “X” (i.e., “poor”) when it exhibited the light transmittance of more than 80%.

4) The appearance was evaluated as follows; the decorative article 2 was rated as “X” (i.e., “poor”) when it had no glittering effect because cracks occurred resulted in causing cloudiness in the decorative portion 4; was rated as “Δ” (i.e., “fair”) when it had a low glittering effect because the metallic layer 13 was viewable but exhibited a brightness (or glossiness) of less than 400 GU, which was found at 60-degree measurement angle in accordance with JIS “5600-4-7 (1999)”; or was rated as “◯” (i.e., “good”) when it had a high glittering effect because the metallic layer 13 was viewable and exhibited a brightness of 400 GU or more.

Table 1 below shows results of the various evaluations.

TABLE 1

| Sample Identification | | No. 1 | No. 2 | | No. 3 | | No. 4 | |
|---|---|---|---|---|---|---|---|---|
| Protective Layer | Layer | Single | Lower | Upper | Lower | Upper | Lower | Upper |
| | Construction | Layer | Layer | Layer | Layer | Layer | Layer | Layer |
| | Component | Acrylic | Aerylic | Acrylic | Acrylic | Acrylic | Acrylic | Acrylic |
| | | Polyurethane | Polyurethane | Resin | Polyurethane | Resin | Polyurethane | Resin |
| | OH Number | 39 for First | 39 | 8 | 39 | 8 | 39 | 8 |
| | (mg-KOH/one-g | Acrylic | | | | | | |
| | Sample) | Polymer, and | | | | | | |
| | | 8 for Second | | | | | | |
| | | Acrylic | | | | | | |
| | | Polymer | | | | | | |
| | Functional | Bonded | None | None | None | Added | None | Added |
| | Group | Benzotriazole | | | | Triazine-based | | Triazine-based |
| | | and Hindered | | | | Compound and | | Compound and |
| | | Amine | | | | Hindered | | Hindered |
| | | | | | | Amine-based | | Amine-based |
| | | | | | | Compound | | Compound |
| | Curing Agent | TDI | TDI | None | TDI | None | TDI | None |
| | | Nurate-type | Nurate- type | | Nurate-type | | Nurate-type | |
| | | Trimer | Trimer | | Trimer | | Trimer | |
| | Elasticity | 1.60 | 2.50 | 0.35 | 2.50 | 0.34 | 2.50 | 0.34 |
| | (GPa) | | | | | | | |
| | Cross-linked | 9.75E−11 | 7.50E−10 | — | 7.50E−10 | — | 7.50E−10 | — |
| | Density | | | | | | | |
| | (mol/cm³) | | | | | | | |
| | Thickness | 4 | 3 | 1.5 | 3 | 1.5 | 3 | 3 |
| | (m) | | | | | | | |

| | | | | | |
|---|---|---|---|---|---|
| Metallic Layer | Component | Cr | ← | ← | ← |
| | Elasticity | 279 | ← | ← | ← |
| | (GPa) | | | | |
| | Cohesive | 389 | ← | ← | ← |
| | Energy | | | | |
| | (kJ/mol) | | | | |
| | Thickness | 30 | ← | ← | ← |
| | (μm) | | | | |

| | | | | |
|---|---|---|---|---|
| Post-Adhesion Test Adherability | ◯ | ◯ | ◯ | ◯ |
| Being-Cut-to-Foil Capability | ◯ | ◯ | ◯ | X |
| Ultraviolet Absorbability | ◯ | X | Δ | ◯ |
| Appearance | Δ | ◯ | ◯ | ◯ |

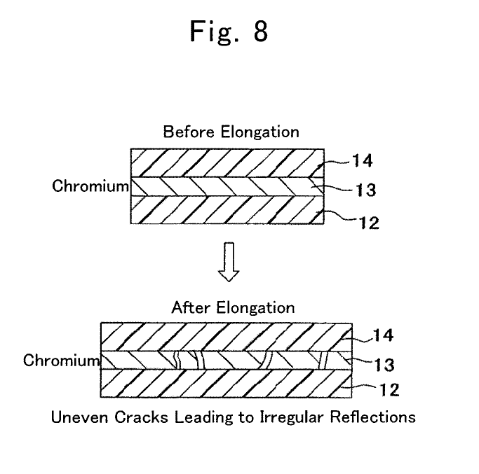

The decorative article 2 according to Sample No. 1 had a favorable being-cut-to-foil capability. However, the decorative article according to Sample No. 1 showed an appearance that had a low glittering effect. When the metallic layer 13 in the decorative article 2 according to Sample No. 1 was observed by an optical microscope, micro-cracks with such an extent of size from two to 10 μm had occurred, as shown in FIG. 7. The microscopic observation revealed that pressurizing the thermal-transferring laminated body 1 applied a tensile stress to the metallic layer 13 at the time of thermal transferring. However, Cr making the metallic layer 13 elongates inefficiently, because it had a high elasticity. Accordingly, cracks had occurred unevenly in the metallic layer 13, as shown in FIG. 8. Consequently, incident lights reflected irregularly at the outermost surface of the metallic layer 13. Therefore, it is believed that the decorative article 2 according to Sample No. 1 had a lowered glittering effect.

The decorative article 2 according to Sample No. 3 had an ultraviolet absorbability rated as “Δ” (i.e., “fair”).

The decorative article 2 according to Sample No. 4 did not have a good being-cut-to-foil capability. In the decorative article 2 according to Sample No. 4, the upper layer 122 of the protective layer 12 exhibited an elasticity that is too low. Moreover, the upper layer 122 had a large thickness. Accordingly, the decorative portion 4 was not separated off quickly at the part, which had been fixed to the upper surface of the substrate 3, from the other part, which had not been fixed to the upper surface of the substrate 3. Consequently, the decorative article 2 according to Sample No. 4 suffered from burrs or flashes occurred that at around the rim or circumference.

The decorative article 2 according to Sample No. 2 had poor ultraviolet-absorption performance, because the acrylic polyurethane resin making the protective layer 12 involved neither a triazine skeleton nor a benzotriazole skeleton that were capable of absorbing ultraviolet rays.

### Experiment No. 2

The decorative articles 2 according to Sample Nos. 1, 2 and 3 were evaluated for the sustainability of their ultraviolet-absorption functions. In Experiment No. 2, a 4-μm-thickness transparent film, which included only a protective layer identical with the protective layer 12 in each of the decorative articles 2 according to Sample Nos. 1, 2 and 3, was formed onto a PET film. The resulting three films were subjected to a water resistance test that was carried out under such a condition as they were immersed in 40° C. hot water for 240 hours. Before and after the water resistance test, the three films were measured for the light transmittance when they were irradiated with lights having wavelengths of from 300 to 450 nm.

Before and after the water resistance test, the film according to Sample No. 1 exhibited a light transmittance which was zero virtually to lights having wavelengths of from 300 to 360 nm that fell in the ultraviolet region. Moreover, the film according to Sample No. 1 did not show light transmittances that varied before and after the water resistance test. On the other hand, the film according to Sample No. 2 had poor ultraviolet-absorption performance, because the protective layer did not include any segment with a triazine skeleton or benzotriazole skeleton that was capable of absorbing ultraviolet rays. Although the film according to Sample No. 3 exhibited a good transmittance to the ultraviolet-region rays before the water resistance test, it showed a declined transmittance to the ultraviolet-region rays after the water resistance test. The declined transmittance resulted from the fact that the triazine-based compound capable of absorbing ultraviolet rays had been exposed in the opposite surfaces of the film according to Sample No. 3 to be pulverized or bled out. On the contrary, bleeding out (like the one occurred in the film according to Sample No. 3) did not occur at all in the film according to Sample No. 1, because benzotriazole skeletons capable of absorbing ultraviolet rays were bonded chemically to acrylic acids in the film according to Sample No. 1.

From the descriptions as set forth above, it was understood that a protective layer has sustainable ultraviolet-absorption performance when it comprises an acrylic polyurethane resin made up of an acrylic polymer, which includes a group with a triazine skeleton or another group with a benzotriazole skeleton, and a curing agent cross-linking the acrylic polymer.

### Sample No. 5

Except that the metallic layer 13 was made of indium, and that the mixed resin forming the protective layer 12 was made free of the second acrylic polymer, a decorative article 2 according to Sample No. 5 was identical with the decorative article 2 according to Sample No. 1.

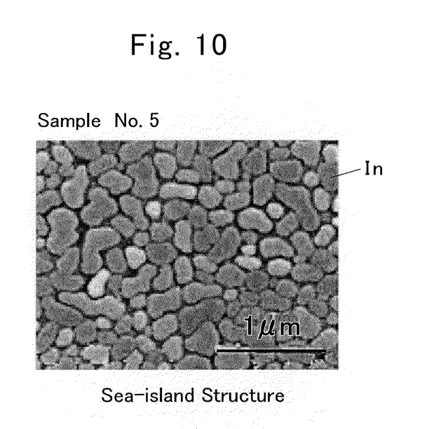

A thermal-transferring laminated body 1 for preparing the decorative article 2 according to Sample No. 5 was the same as the thermal-transferring laminated body 1 according to Sample No. 1 except for the following: forming a metallic layer 13 made of indium; and forming a protective layer 12 made of the mixed resin free from the second acrylic polymer. In the thermal-transferring laminated body 1 according to Sample No. 5, the metallic layer 13 was made of 50-nm-thickness indium, and was formed by a physical vapor deposition (or PVD) process. FIG. 10 shows an SEM photograph of the metallic layer 13 in the decorative article 2 according to Sample No. 5. The metallic layer 13 took on a sea-island structure in which the indium was scattered about in a shape of islands whose size was from 0.2 μm or more to 0.4 μm or less. The indium used for the metallic layer 13 exhibited an elasticity of 11 GPa, and had a cohesive energy of 230 kJ/mol. The protective layer 12 was formed of a mixed resin that was made of a first acrylic polymer, and a curing agent. The mixed resin contained the curing agent in an amount of 49 parts by mass with respect to a mass of the first acrylic polymer taken as 100 parts by mass.

In the decorative article 2 according to Sample No. 5, the protective layer 12 was made of an acrylic polyurethane resin in which a first acrylic polymer was cross-linked by a curing agent including a TDI nurate trimer. The first acrylic polymer used in the decorative article 2 according to Sample No. 5 was the same as the first acrylic polymer used in the decorative article 2 according to Sample No. 1. The protective layer 12 of the decorative article 2 according to Sample No. 5 had a cross-linked density of “7.50E-10” (i.e., 7.50×10⁻¹⁰) mol/cm³, and exhibited an elasticity of 2.50 GPa.

The decorative article 2 according to Sample No. 5 was evaluated for the various characteristics in the same manner as described in the chapter titled “(Experiment No. 1).” As a result, the decorative article 2 according to Sample No. 5 was found to have a high glittering effect that the metallic layer 13 expressed, and was also found to have a satisfactory appearance. The high glittering effect and satisfactory appearance were due to the indium in the metallic layer 13 that took on a sea-island structure as shown in FIG. 10. Accordingly, even after the metallic layer 13 was elongated by the thermal transferring operation, the sea-island structure was stretched uniformly in the planar direction. Consequently, it is believed that the metallic layer 13 exhibited a post-elongation optical reflectance that was maintained to be identical with a pre-elongation optical reflectance.

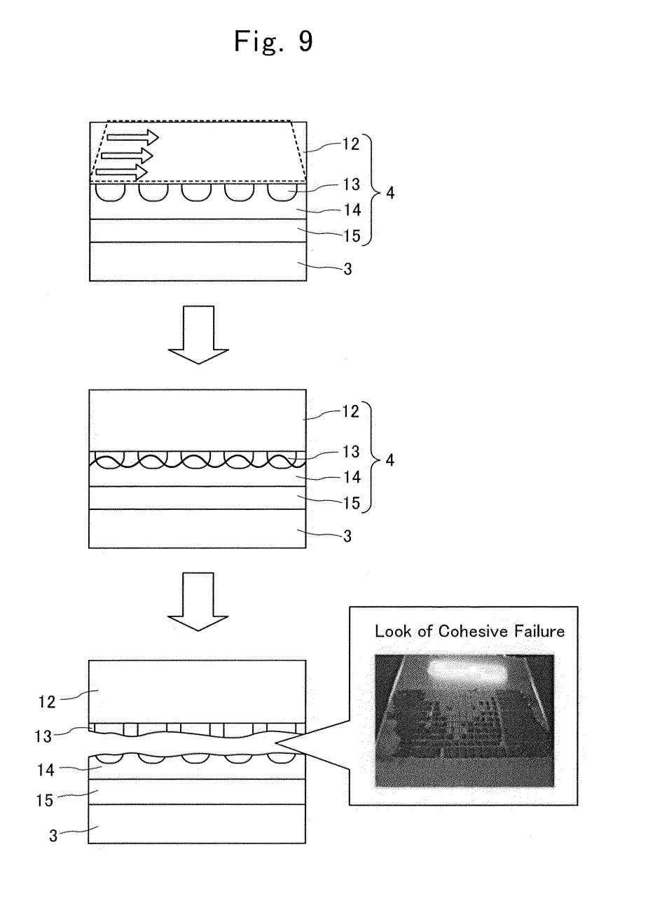

Moreover, the decorative article 2 according to Sample No. 5 was rated as “X” (i.e., “poor”) in terms of the adherability, because the protective layer 12 had peeled off from the substrate 3 during the adhesion test. In FIG. 9, the right lowermost figure shows the decorative article 2 according to Sample No. 5 after the adhesion test. As can be seen from the right lowermost figure in FIG. 9, the metallic layer 13 underwent a cohesive failure, so that the metallic layer 13 and protective layer 12 had peeled off from the substrate 3 after the adhesion test. As illustrated in the uppermost figure in FIG. 9, an internal stress accumulated in the protective layer 12 because of its own contraction due to the curing. The metallic layer 13 in contact with the protective layer 12 was made of indium. As illustrated in FIG. 3, the indium had a low elasticity as well as a low cohesive energy, and exerted a small cohesive force. Accordingly, the metallic layer 13 could follow up the protective layer 12 that cohered together. On the other hand, since the protective layer 12 exhibited such a high elasticity as 2.50 GPa, a shear stress accumulated between the protective layer 12 and the metallic layer 13, as shown in the second figure from the top in FIG. 9. Consequently, when the decorative article 2 according to Sample No. 5 in which the shear stress had thus accumulated was subjected to the tape adhesion test, the metallic layer 13 underwent a cohesion failure. As a result, it is believed that the metallic layer 12 and protective layer 13 had peeled off from one of the opposite surfaces of the substrate 3, as shown in the left lowermost figure in FIG. 9. Note however that the decorative article 2 according to Sample No. 5 had a being-cut-to-foil capability and ultraviolet-absorption capability that were satisfactory.

### Sample No. 6

A decorative article 2 according to Sample No. 6 was produced in the same manner as the decorative article 2 according to Sample No. 5, except for the setting that an HDI adduct was used as the curing agent. The protective layer 12 was made of an acrylic polyurethane resin in which the first acrylic polymer was cross-linked by the HDI adduct. The protective layer 12 of the decorative article 2 according to Sample No. 6 had a cross-linked density of “1.50E-10” (i.e., 1.50×10⁻¹⁰) mol/cm³, and exhibited an elasticity of 2.10 GPa.

The decorative article 2 according to Sample No. 6 was evaluated for the various characteristics in the same manner as described in the chapter titled “(Experiment No. 1).” As a result, the decorative article 2 according to Sample No. 6 was found to have a being-cut-to-foil capability and ultraviolet-absorption capability that were rated as “0” (i.e., “good”), respectively. However, the decorative article 2 according to Sample No. 6 was rated as “X” (i.e., “poor”) in terms of the adherability, because the protective layer 2 had peeled off from the substrate 3 in the adhesion test. Note however that the decorative article 2 according to Sample No. 6 had such a high glittering effect that the appearance was rated as “◯” (i.e., “good”).

### Sample No. 7

A decorative article 2 according to Sample No. 7 was produced in the same manner as the decorative article 2 according to Sample No. 5, except for the setting that an HDI nurate trimer was used as the curing agent. The protective layer 12 was made of an acrylic polyurethane resin in which the first acrylic polymer was cross-linked by the HDI nurate trimer. The protective layer 12 of the decorative article 2 according to Sample No. 7 had a cross-linked density of “1.90E-10” (i.e., 1.90×10⁻¹⁰ mol/cm³, and exhibited an elasticity of 1.90 GPa.

The decorative article 2 according to Sample No. 7 was evaluated for the various characteristics in the same manner as described in the chapter titled “(Experiment No. 1).” As a result, the decorative article 2 according to Sample No. 7 was found to have a being-cut-to-foil capability, ultraviolet-absorption capability and appearance that were rated as “◯” (i.e., “good”), respectively. Moreover, the decorative article 2 according to Sample No. 7 was also rated as “◯” (i.e., “good”) in terms of the adherability, because any peeling off did not occur at all even during the adhesion test.

### Sample No. 8

A decorative article 2 according to Sample No. 8 was produced in the same manner as the decorative article 2 according to Sample No. 5, except for the setting that an HDI nurate pentamer and heptamer were used as the curing agent. The protective layer 12 was made of an acrylic polyurethane resin in which the first acrylic polymer was cross-linked by the HDI nurate pentamer and heptamer. The protective layer 12 of the decorative article 2 according to Sample No. 8 had a cross-linked density of “1.80E-10” (i.e., 1.80×10⁻¹⁰) mol/cm³, and exhibited an elasticity of 2.00 GPa.

The decorative article 2 according to Sample No. 8 was evaluated for the various characteristics in the same manner as described in the chapter titled “(Experiment No. 1).” As a result, the decorative article 2 according to Sample No. 8 was rated as “◯” (i.e., “good”) in terms of all of the adherability, being-cut-to-foil capability, ultraviolet-absorption capability and appearance.

### Sample No. 9

A decorative article 2 according to Sample No. 9 was produced in the same manner as the decorative article 2 according to Sample No. 5, except for the setting that an IPDI adduct was used as the curing agent. The protective layer 12 was made of an acrylic polyurethane resin in which the first acrylic polymer was cross-linked by the IPDI adduct. The protective layer 12 of the decorative article 2 according to Sample No. 9 had a cross-linked density of “2.30E-10” (i.e., 2.30×10⁻¹⁰) mol/cm³, and exhibited an elasticity of 2.00 GPa.

The decorative article 2 according to Sample No. 9 was evaluated for the various characteristics in the same manner as described in the chapter titled “(Experiment No. 1).” As a result, the decorative article 2 according to Sample No. 9 was rated as “◯” (i.e., “good”) in terms of all of the adherability, being-cut-to-foil capability, ultraviolet-absorption capability and appearance.

### Sample No. 10

A decorative article 2 according to Sample No. 10 was produced in the same manner as the decorative article 2 according to Sample No. 5, except for the setting that a thermal-transferring laminated body 1 comprising a protective layer 12 that was made of a first acrylic polymer, a second acrylic polymer, and an HDI nurate trimer serving as a curing agent. The first acrylic polymer and second acrylic polymer used in the decorative article 2 according to Sample No. 10 were the same as the first acrylic polymer and second acrylic polymer used in the decorative article 2 according to Sample No. 1. When a summed mass of the first acrylic polymer and second acrylic polymer contained in the protective layer 12 of the thermal-transferring laminated body 1 was taken as 100% by mass, a mass ratio of the first acrylic polymer and the second acrylic polymer was (First Acrylic Polymer):(Second Acrylic Polymer)=(95% by Mass): (5% by Mass).

The protective layer 12 of the decorative article 2 according to Sample No. 10 was made of an acrylic polyurethane resin in which the first acrylic polymer and second acrylic polymer were cross-linked by the HDI nurate trimer. The protective layer 12 of the decorative article 2 according to Sample No. 10 had a cross-linked density of “1.77E-10” (i.e., 1.77×10⁻¹⁰) mol/cm³, and exhibited an elasticity of 1.62 GPa.

The decorative article 2 according to Sample No. 10 was evaluated for the various characteristics in the same manner as described in the chapter titled “(Experiment No. 1).” As a result, the decorative article 2 according to Sample No. 10 was rated as “◯” (i.e., “good”) in terms of all of the adherability, being-cut-to-foil capability, ultraviolet-absorption capability and appearance.

### Sample No. 11

A decorative article 2 according to Sample No. 11 was produced in the same manner as the decorative article 2 according to Sample No. 10, except for the setting that amass ratio of the first acrylic polymer and the second acrylic polymer was (First Acrylic Polymer):(Second Acrylic Polymer)=(85% by Mass):(15% by Mass) when a summed mass of the first acrylic polymer and second acrylic polymer contained in the protective layer 12 of the thermal-transferring laminated body 1 was taken as 100% by mass.

The protective layer 12 of the decorative article 2 according to Sample No. 11 had a cross-linked density of “1.55E-10” (i.e., 1.55×10⁻¹⁰) mol/cm³, and exhibited an elasticity of 1.48 GPa.

The decorative article 2 according to Sample No. 11 was evaluated for the various characteristics in the same manner as described in the chapter titled “(Experiment No. 1).” As a result, the decorative article 2 according to Sample No. 11 was rated as “◯” (i.e., “good”) in terms of the being-cut-to-foil capability, ultraviolet-absorption capability and appearance. Besides, with regard to the adherability, the decorative article 2 according to Sample No. 11 was rated as “⊚” (i.e., “very good”), because the protective layer 12 was firmly adhered onto the substrate 3 via the metallic layer 13, top layer 14 and adhesive layer 15.

### Sample No. 12

A decorative article 2 according to Sample No. 12 was produced in the same manner as the decorative article 2 according to Sample No. 10, except for the setting that amass ratio of the first acrylic polymer and the second acrylic polymer was (First Acrylic Polymer):(Second Acrylic Polymer)=(70% by Mass):(30% by Mass) when a summed mass of the first acrylic polymer and second acrylic polymer contained in the protective layer 12 of the thermal-transferring laminated body 1 was taken as 100% by mass.

The protective layer 12 of the decorative article 2 according to Sample No. 12 had a cross-linked density of “9.30E-11” (i.e., 9.30×10⁻¹¹) mol/cm³, and exhibited an elasticity of 1.52 GPa.

The decorative article 2 according to Sample No. 12 was evaluated for the various characteristics in the same manner as described in the chapter titled “(Experiment No. 1).” As a result, the decorative article 2 according to Sample No. 12 was rated as “◯” (i.e., “good”) in terms of the being-cut-to-foil capability, ultraviolet-absorption capability and appearance. Besides, with regard to the adherability, the decorative article 2 according to Sample No. 12 was rated as “⊚” (i.e., “very good”), because the protective layer 12 was firmly adhered onto the substrate 3 via the metallic layer 13, top layer 14 and adhesive layer 15.

### Sample No. 13

A decorative article 2 according to Sample No. 13 was produced in the same manner as the decorative article 2 according to Sample No. 10, except for the setting that amass ratio of the first acrylic polymer and the second acrylic polymer was (First Acrylic Polymer):(Second Acrylic Polymer)=(50% by Mass):(50% by Mass) when a summed mass of the first acrylic polymer and second acrylic polymer contained in the protective layer 12 of the thermal-transferring laminated body 1 was taken as 100% by mass.

The protective layer 12 of the decorative article 2 according to Sample No. 13 had a cross-linked density of “5.02E-11” (i.e., 5.02×10⁻¹¹) mol/cm³, and exhibited an elasticity of 1.38 GPa.

The decorative article 2 according to Sample No. 13 was evaluated for the various characteristics in the same manner as described in the chapter titled “(Experiment No. 1).” As a result, the decorative article 2 according to Sample No. 13 was rated as “◯” (i.e., “good”) in terms of the being-cut-to-foil capability, ultraviolet-absorption capability and appearance. Besides, with regard to the adherability, the decorative article 2 according to Sample No. 13 was rated as “⊚” (i.e., “very good”), because the protective layer 12 was firmly adhered onto the substrate 3 via the metallic layer 13, top layer 14 and adhesive layer 15.

### Sample No. 14

A decorative article 2 according to Sample No. 14 was produced in the same manner as the decorative article 2 according to Sample No. 10, except for the setting that a mass ratio of the first acrylic polymer and the second acrylic polymer was (First Acrylic Polymer):(Second Acrylic Polymer)=(40% by Mass):(60% by Mass) when a summed mass of the first acrylic polymer and second acrylic polymer contained in the protective layer 12 of the thermal-transferring laminated body 1 was taken as 100% by mass.

The protective layer 12 of the decorative article 2 according to Sample No. 14 had a cross-linked density of “2.69E-11” (i.e., 2.69×10⁻¹¹) mol/cm³, and exhibited an elasticity of 1.08 GPa.

The decorative article 2 according to Sample No. 14 was evaluated for the various characteristics in the same manner as described in the chapter titled “(Experiment No. 1).” As a result, the decorative article 2 according to Sample No. 14 was rated as “◯” (i.e., “good”) in terms of the being-cut-to-foil capability, ultraviolet-absorption capability and appearance. Moreover, the decorative article 2 according to Sample No. 14 was rated as “⊚” (i.e., “very good”) in terms of the adherability, because the protective layer 12 was firmly adhered onto the substrate 3 via the metallic layer 13, top layer 14 and adhesive layer 15 even after the adhesion test.

### Sample No. 15

A decorative article 2 according to Sample No. 15 was produced in the same manner as the decorative article 2 according to Sample No. 10, except for the setting that a mass ratio of the first acrylic polymer and the second acrylic polymer was (First Acrylic Polymer):(Second Acrylic Polymer)=(30% by Mass):(70% by Mass) when a summed mass of the first acrylic polymer and second acrylic polymer contained in the protective layer 12 of the thermal-transferring laminated body 1 was taken as 100% by mass.

The protective layer 12 of the decorative article 2 according to Sample No. 15 had a cross-linked density of “1.35E-11” (i.e., 1.35×10⁻¹¹) mol/cm³, and exhibited an elasticity of 0.92 GPa.

The decorative article 2 according to Sample No. 15 was evaluated for the various characteristics in the same manner as described in the chapter titled “(Experiment No. 1).” As a result, the decorative article 2 according to Sample No. 15 was rated as “∘” (i.e., “good”) in terms of the adherability, being-cut-to-foil capability, ultraviolet-absorption capability and appearance.

### Sample No. 16

A decorative article 2 according to Sample No. 16 was produced in the same manner as the decorative article 2 according to Sample No. 10, except for the setting that a mass ratio of the first acrylic polymer and the second acrylic polymer was (First Acrylic Polymer):(Second Acrylic Polymer)=(15% by Mass):(85% by Mass) when a summed mass of the first acrylic polymer and second acrylic polymer contained in the protective layer 12 of the thermal-transferring laminated body 1 was taken as 100% by mass.

The protective layer 12 of the decorative article 2 according to Sample No. 16 had a cross-linked density of “8.74E-12” (i.e., 8.74×10⁻¹²) mol/cm³, and exhibited an elasticity of 0.47 GPa.

The decorative article 2 according to Sample No. 16 was evaluated for the various characteristics in the same manner as described in the chapter titled “(Experiment No. 1).” As a result, the decorative article 2 according to Sample No. 16 was rated as “◯” (i.e., “good”) in terms of the adherability, being-cut-to-foil capability and ultraviolet-absorption capability.

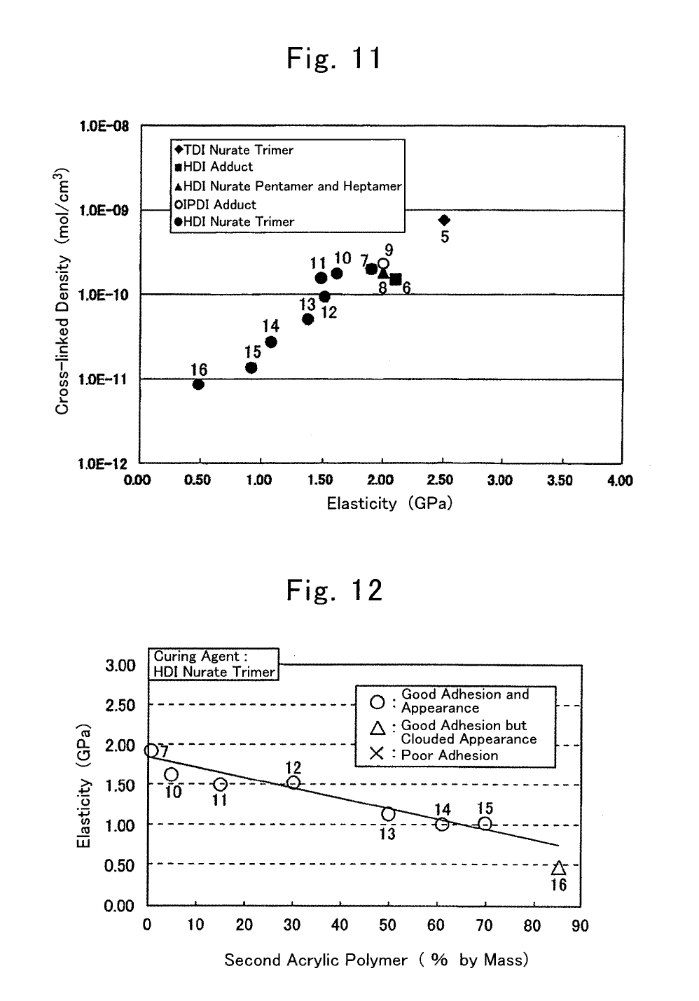

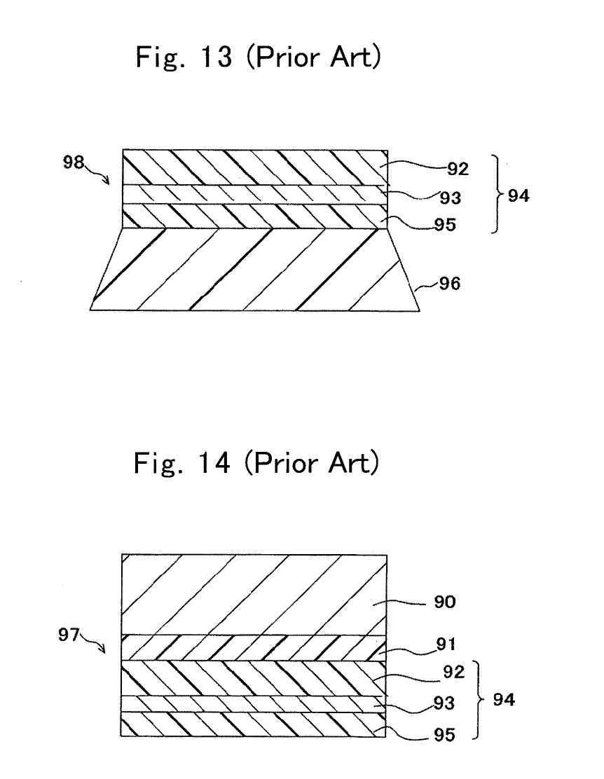

Table 2 below summarizes the following altogether: the blending ratios of the first and second acrylic polymers and the type of the curing agents in the protective layer 12 of the thermal-transferring laminated bodies 1 according to Sample Nos. 5 through 16; the cross-linked density in the productive layer 12 of the decorative articles 2 according to Sample Nos. 5 through 16 and the elasticity thereof; as well as the appearance of the decorative articles 2 according to Sample Nos. 5 through 16. Moreover, FIG. 11 illustrates a scatter diagram showing the relationships between the cross-linked density in the protective layer 12 of the decorative articles 2 according to Sample Nos. 5 through 6 and the elasticity thereof. In addition, FIG. 12 illustrates a graph showing the relationship between the blended ratio of the second acrylic polymer in the protective layer 12 of the decorative articles 2 according to Sample No. 7 and Sample Nos. 10 through 16 and the elasticity exhibited by the protective layer 12 of the decorative articles 2. In FIG. 12, the symbol, “◯,” indicates that the decorative portion 4 of the decorative articles 2 exhibited a good adherability, and had a good appearance; the symbol, “Δ,” indicates that the decorative portion 4 of the decorative articles 2 exhibited a good adherability, but had a poor appearance; and the symbol, “X,” indicates that the decorative portion 4 of the decorative articles 2 exhibited a poor adherability.

As summarized in Table 2, and as illustrated in FIG. 11, it was understood that the relationship between the elasticity and cross-linked density depends greatly on the type of the curing agents. For example, it was found out that making the curing agent of an identical HDI nurate, and increasing the mass ratio of the second acrylic polymer in the summed mass of the first and second acrylic polymers lead to causing the protective layer 12 of the decorative portion 4 to exhibit a declined elasticity.

As illustrated in FIG. 12, the decorative portion 4 of the decorative articles 2 according to Sample Nos. 7 and 10 through 16 exhibited a good adherability, and had a good appearance when the second acrylic polymer accounted for from 5 to 85% by mass in a summed mass of the first and second acrylic polymers in the protective layer 12 of the decorative article 4.

The decorative articles 2 according to Sample Nos. 5 through 16 were evaluated for the sustainability of their ultraviolet-absorption functions in the same manner as described in the chapter titled “(Experiment No. 2).” As a result, before and after the water resistance test, the films according to Sample Nos. 5 through 16 also exhibited a light transmittance that was zero virtually to lights having wavelengths of from 300 to 360 nm that fell in the ultraviolet region. Moreover, the light transmittances did not change at all before and after the water resistance test. Since benzotriazole skeletons capable of absorbing ultraviolet rays were bonded chemically to acrylic acids in the films according to Sample Nos. 5 through 16 as well, the decorative articles 2 according to Sample Nos. 5 through 16 were found to have sustainable ultraviolet-absorption performance.

TABLE 2

| | Protective Layer | | | | | | | | | |
|---|---|---|---|---|---|---|---|---|---|---|
| | Blended Ratio | | | | | | | | | |
| | (% by mass) | | | Cross- | | | Post- | | | |
| | 1st | 2nd | | linked | | | adhesion | Being- | | |
| Sample | Acrylic | Acrylic | Curing | Density | Elasticity | Metallic | test | cut-to-foil | Ultraviolet | |
| Identification | Polymer | Polymer | Agent | (mol/cm³) | (GPa) | Layer | Adherability | Capability | Absorbability | Appearance |
| No. 5 | 100 | 0 | TDI | 7.50E−10 | 2.50 | In | X | ◯ | ◯ | ◯ |
| | | | Nurate | | | | | | | |
| | | | Trimer | | | | | | | |
| No. 6 | 100 | 0 | HDI | 1.50E−10 | 2.10 | ↑ | X | ◯ | ◯ | ◯ |
| | | | Adduct | | | | | | | |
| No. 7 | 100 | 0 | HDI | 1.90E−10 | 1 .90 | ↑ | ◯ | ◯ | ◯ | ◯ |
| | | | Nurate | | | | | | | |
| | | | Trimer | | | | | | | |
| No. 8 | 100 | 0 | HDI | 1.80E−10 | 2.00 | ↑ | ◯ | ◯ | ◯ | ◯ |
| | | | Nurate | | | | | | | |
| | | | Pentamer | | | | | | | |
| | | | & | | | | | | | |
| | | | Heptamer | | | | | | | |
| No. 9 | 100 | 0 | IPDI | 2.30E−10 | 2.00 | ↑ | ◯ | ◯ | ◯ | ◯ |
| | | | Adduct | | | | | | | |
| No. 10 | 95 | 5 | HDI | 1.77E−10 | 1.62 | ↑ | ◯ | ◯ | ◯ | ◯ |
| | | | Nurate | | | | | | | |
| | | | Trimer | | | | | | | |
| No. 11 | 85 | 15 | | 1.55E−10 | 1.48 | ↑ | ⊚ | ◯ | ◯ | ◯ |
| No. 12 | 70 | 30 | | 9.30E−11 | 1.52 | ↑ | ⊚ | ◯ | ◯ | ◯ |
| No. 13 | 50 | 50 | | 5.02E−11 | 1.38 | ↑ | ⊚ | ◯ | ◯ | ◯ |
| No. 14 | 40 | 60 | | 2.69E−11 | 1.08 | ↑ | ⊚ | ◯ | ◯ | ◯ |
| No. 15 | 30 | 70 | | 1.35E−11 | 0.92 | ↑ | ◯ | ◯ | ◯ | ◯ |
| No. 16 | 15 | 85 | | 8.74E−12 | 0.47 | ↑ | ◯ | ◯ | ◯ | Δ |

Having now fully described the present invention, it will be apparent to one of ordinary skill in the art that many changes and modifications can be made thereto without departing from the spirit or scope of the present invention as set forth herein including the appended claims.

What is claimed is:

1. A decorative article comprising:
a substrate having opposite surfaces;
a decorative portion formed on one of the opposite surfaces of the substrate, and including an adhesive layer made of resin, a metallic layer, and a protective layer made of resin, the adhesive layer, the metallic layer and the protective layer laminated in this order from the one of the opposite surfaces of the substrate;
the metallic layer made of a metal exhibiting an elasticity of from 10 GPa or more to 150 GPa or less; and
the protective layer exhibiting an elasticity of from 0.5 GPa or more to 2.0 GPa or less.

2. The decorative article according to claim 1, wherein the protective layer includes a polyurethane resin.

3. The decorative article according to claim 1, wherein the protective layer includes a first acrylic polymer, and a curing agent with isocyanate groups.

4. The decorative article according to claim 3, wherein the protective layer further includes, in addition to the curing agent and the first acrylic polymer exhibiting a hydroxyl number, a second acrylic polymer exhibiting a hydroxyl number that is smaller than the hydroxyl number of the first acrylic polymer.

5. The decorative article according to claim 3, wherein the first acrylic polymer exhibits a hydroxyl number of from 20-mg KOH or more to 200-mg KOH or less per one-gram sample.

6. The decorative article according to claim 4, wherein the second acrylic polymer exhibits a hydroxyl number of from more than 0-mg KOH to 30-mg KOH or less per one-gram sample.

7. The decorative article according to claim 4, wherein the first acrylic polymer and/or the second acrylic polymer has one or more members selected from the group consisting of groups with a hindered amine skeleton, groups with a benzotriazole skeleton, and groups with a triazine skeleton.

8. The decorative article according to claim 1, wherein the decorative portion further includes a top layer intervening between the adhesive layer and the metallic layer, and made of resin that is identical with the resin making the protective layer.

9. The decorative article according to claim 1, wherein the metal making the metallic layer includes one or more members selected from the group consisting of indium, tin, silver, aluminum and copper.

10. The decorative article according to claim 1, wherein the metallic layer takes on a sea-island structure in which the metal is scattered about in a shape of islands.

11. A laminated body for thermal transferring, the laminated body comprising a protective layer made of resin, a metallic layer and an adhesive layer made of resin, the protective layer, the metallic layer and the adhesive layer laminated in this order on a film;
the metallic layer including a metal exhibiting an elasticity of from 10 GPa or more to 150 GPa or less; and
the protective layer exhibiting an elasticity of from 0.5 GPa or more to 2.0 GPa or less.

12. The laminated body according to claim 11, wherein the protective layer includes a polyurethane resin.

13. The laminated body according to claim 11, wherein the protective layer includes a first acrylic polymer, and a curing agent with isocyanate groups.

14. The laminated body according to claim 13, wherein the protective layer further includes, in addition to the curing agent and the first acrylic polymer exhibiting a hydroxyl number, a second acrylic polymer exhibiting a hydroxyl number that is smaller than the hydroxyl number of the first acrylic polymer.

15. The laminated body according to claim 13, wherein the first acrylic polymer exhibits a hydroxyl number of from 20-mg KOH or more to 200-mg KOH or less per one-gram sample.

16. The laminated body according to claim 14, wherein the second acrylic polymer exhibits a hydroxyl number of from more than 0-mg KOH to 30-mg KOH or less per one-gram sample.

17. The laminated body according to claim 14, wherein the first acrylic polymer and/or the second acrylic polymer has one or more members selected from the group consisting of groups with a hindered amine skeleton, groups with a benzotriazole skeleton, and groups with a triazine skeleton.

18. The laminated body according to claim 11 further including a top layer intervening between the adhesive layer and the metallic layer, and made of resin that is identical with the resin making the protective layer.

19. The laminated body according to claim 11, wherein the metal making the metallic layer includes one or more members selected from the group consisting of indium, tin, silver, aluminum and copper.

20. The laminated body according to claim 11, wherein the metallic layer takes on a sea-island structure in which the metal is scattered about in a shape of islands.
